(19) United States
(12) Patent Application Publication
(10) Pub. No.: US 2026/0212129 A1
(43) Pub. Date: Jul. 23, 2026

(54) Systems and Methods for Dynamic Human-PCM Interaction Modeling in Operational Environments

(71) Applicant: AtomBeam Technologies Inc., Moraga, CA (US)

(72) Inventor: Brian Galvin, Silverdale, WA (US)

(21) Appl. No.: 19/399,611

(22) Filed: Nov. 24, 2025

Related U.S. Application Data
(63) Continuation-in-part of application No. 19/315,849, filed on Sep. 1, 2025, now Pat. No. 12,572,830.
Application No. 19/315,849 is a continuation-in-part of application No. 19/294,125, filed on Aug. 7, 2025, now Pat. No. 12,579,437.
Application No. 19/294,125 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
Application No. 19/294,125 is a continuation-in-part of application No. 19/178,873, filed on Apr. 15, 2025, now Pat. No. 12,608,631.
Application No. 19/178,873 is a continuation-in-part of application No. 19/177,611, filed on Apr. 13, 2025, now Pat. No. 12,572,471.
Application No. 19/177,611 is a continuation-in-part of application No. 19/051,193, filed on Feb. 12, 2025, now Pat. No. 12,387,050.
(63) Continuation-in-part of application No. 19/397,844, filed on Nov. 21, 2025.
Application No. 19/397,844 is a continuation-in-part of application No. 19/379,579, filed on Nov. 4, 2025.
Application No. 19/379,579 is a continuation-in-part of application No. 19/378,949, filed on Nov. 4, 2025.
Application No. 19/378,949 is a continuation-in-part of application No. 19/377,013, filed on Nov. 2, 2025.
Application No. 19/377,013 is a continuation-in-part of application No. 19/352,457, filed on Oct. 7, 2025.
Application No. 19/352,457 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/051,193 is a continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/657,719, filed on May 7, 2024, now Pat. No. 12,166,506.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 19/377,013 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 19/378,949 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/379,579 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 19/397,844 is a continuation-in-part of application No. 19/329,330, filed on Sep. 15, 2025.
Application No. 19/329,330 is a continuation-in-part of application No. 19/328,094, filed on Sep. 12, 2025, now Pat. No. 12,632,663.
Application No. 19/397,844 is a continuation-in-part of application No. 19/003,258, filed on Dec. 27, 2024.
Application No. 19/003,258 is a continuation of application No. 18/822,203, filed on Sep. 1, 2024, now Pat. No. 12,229,679.
Application No. 18/822,203 is a continuation-in-part of application No. 18/427,716, filed on Jan. 30, 2024, now Pat. No. 12,093,972.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A computer system and method for dynamic interaction between human operators and persistent cognitive machines is disclosed. The invention enables adaptive collaboration in operational environments by integrating multimodal translation, cognitive processing, load balancing, trust calibration, operational learning, and team coordination. Human inputs such as voice, gestures, biometric signals, and contextual data are converted into prompts for a cognitive core that processes reasoning through multi-stage language models and thought caching. Operator cognitive load is quantified by combining physiological and behavioral indicators, and tasks are dynamically allocated between human and machine based on load, task complexity, and trust. Operational modes transition between advisory, collaborative, autonomous, and override states with safeguards to ensure stability and human primacy. Outputs are adapted in detail, modality, and timing according to operator state. Continuous learning captures interaction patterns and team dynamics, providing personalized adaptations, distributed knowledge sharing, and resilience to component failures.

### CROSS-REFERENCE TO RELATED APPLICATIONS

Priority is claimed in the application data sheet to the following patents or patent applications, each of which is expressly incorporated herein by reference in its entirety:
Ser. No. 19/315,849
Ser. No. 19/294,125
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359
Ser. No. 19/178,873
Ser. No. 19/177,611
Ser. No. 19/051,193
Ser. No. 19/397,844
Ser. No. 19/379,579
Ser. No. 19/378,949
Ser. No. 19/377,013
Ser. No. 19/352,457
Ser. No. 19/321,173
Ser. No. 19/284,115
63/847,082
63/847,091
63/847,096
63/847,101
63/847,969
Ser. No. 19/038,801
Ser. No. 18/818,593
Ser. No. 18/657,719
Ser. No. 18/410,980
Ser. No. 18/537,728
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 19/328,094
Ser. No. 19/363,675
Ser. No. 19/351,286
Ser. No. 19/329,330
Ser. No. 19/003,258
Ser. No. 18/822,203
Ser. No. 18/427,716

### BACKGROUND OF THE INVENTION

### Field of the Art

The present invention relates generally to artificial intelligence and human-machine teaming, and more specifically to systems and methods for adaptive collaboration between human operators and persistent cognitive machines.

### Discussion of the State of the Art

Human-machine interaction technologies have advanced significantly with the development of artificial intelligence, natural language processing, and multimodal sensing systems. Existing systems provide operators with decision support, automation, and monitoring tools that improve efficiency in many domains, including defense, aviation, medical operations, and industrial control. These systems typically rely on fixed authority levels, predefined interaction patterns, or static human-machine interfaces.

Despite these advances, the state of the art remains limited in its ability to dynamically adapt to operator state and situational demands. Current approaches often treat the human as either the primary decision-maker or as a supervisory controller of autonomous systems, without mechanisms for real-time adjustment of cognitive load sharing. Static interfaces may overwhelm operators during periods of high workload or underutilize human expertise during low workload conditions. Furthermore, trust in machine autonomy is rarely quantified or used as a control variable, leading either to over-reliance on automation or unnecessary human intervention.

Another limitation in the art is the lack of continuous learning mechanisms that personalize machine behavior to the unique preferences, cognitive styles, and team dynamics of operators. While adaptive user interfaces exist in limited contexts, few systems integrate operator physiological state, task complexity, and trust evolution into a unified model for authority allocation and collaboration. Existing systems also tend to degrade poorly under component failures, providing little resilience in mission-critical settings.

What is needed is a system and method that integrates persistent cognitive machine reasoning with dynamic human state monitoring, multimodal translation, adaptive load balancing, trust-calibrated authority management, and continuous operational learning, thereby enabling effective real-time collaboration between human operators and artificial systems in demanding operational environments.

### SUMMARY OF THE INVENTION

Accordingly, the inventor has conceived and reduced to practice a computer system and method for dynamic human-persistent cognitive machine interaction modeling in operational environments. The invention enables adaptive collaboration between human operators and cognitive systems by integrating multimodal translation, persistent reasoning, cognitive load assessment, trust calibration, authority management, continuous learning, failure resilience, distributed adaptation, and team coordination. Through these mechanisms, the invention provides a framework in which human cognitive state directly shapes artificial reasoning processes and outputs, allowing the machine to operate as an adaptive partner across advisory, collaborative, autonomous, and override roles.

In an embodiment, a computer system is configured to execute instructions that receive multimodal inputs from a human operator, including one or more of voice commands, gestures, biometric signals, or environmental context. A translation engine converts the multimodal inputs into prompts suitable for a persistent cognitive core, which processes the prompts using domain-specific reasoning structures, multi-stage language model processing, and thought caching to generate reasoning outputs. A cognitive load balancer computes a cognitive load score for the human operator by fusing multiple physiological or behavioral signals normalized against baseline values. Tasks are then allocated between the human operator and the cognitive core based on the cognitive load score, task complexity assessments, and a trust metric that quantifies operator confidence in autonomous execution. An operational mode is selected from among advisory, collaborative, autonomous, and override modes according to the trust metric and cognitive load score. Reasoning outputs are adapted into human-appropriate formats by adjusting level of detail, output modality, or delivery timing. An operational learning system captures operator interaction patterns, performance outcomes, and team dynamics, and modifies authority thresholds, output templates, or reasoning pathways to continuously improve collaboration.

In an aspect of an embodiment, computing the cognitive load score includes weighting and summing normalized values of physiological and behavioral indicators such as pupil dilation, heart rate variability, gaze entropy, response latency, blink suppression, and skin conductance amplitude.

In an aspect of an embodiment, task allocation is performed through optimization that minimizes a total cost including human effort, machine effort, and handoff penalties, subject to constraints that limit human load, require minimum machine confidence for autonomy, and restrict excessive handoffs.

In an aspect of an embodiment, the trust metric is determined from a base value that is adjusted by incremental increases for successful autonomous actions, decreases for operator overrides or critical errors, and modifiers based on decision consistency or recovery from prior errors.

In an aspect of an embodiment, operational mode selection is implemented through a state machine that transitions between advisory, collaborative, autonomous, and override modes using thresholds on trust and cognitive load, with hysteresis bands, minimum mode durations, and cooldown periods to prevent oscillation.

In an aspect of an embodiment, adapting reasoning outputs includes varying the level of detail, modality, and pacing of delivery in accordance with operator cognitive load, providing concise advisories during high workload and more detailed explanations during low workload.

In an aspect of an embodiment, operational learning includes generating reusable reasoning structures from successful interactions and adjusting authority thresholds based on accumulated trust and operator performance.

In an aspect of an embodiment, the system degrades gracefully under component failure by outputting raw reasoning chains if a translation engine fails, reverting to human-in-loop control if a cognitive load balancer fails, retaining validated parameters if a learning system fails, or alerting the operator and preserving state if a cognitive core fails.

In an aspect of an embodiment, distributed adaptation is achieved by sharing abstracted adaptation patterns across multiple persistent cognitive machines while excluding raw operational data to preserve privacy and security.

In an aspect of an embodiment, team coordination includes monitoring workload distribution across multiple operators, redistributing tasks to balance cognitive loads, analyzing communication patterns, and generating collective decision outcomes through weighted voting or consensus modeling.

### BRIEF DESCRIPTION OF THE DRAWING FIGURES

FIG. 1 is a block diagram illustrating an exemplary system architecture for dynamic human-PCM interaction modeling in operational environments, showing major subsystems and information flows between human operators and PCM components.

FIG. 2 is a block diagram illustrating an exemplary architecture of a cognitive load balancer for a dynamic human-PCM interaction system, depicting subsystems for monitoring operator state, allocating tasks, managing authority, and coordinating task handoffs.

FIG. 3 is a block diagram illustrating an exemplary architecture of a human-PCM translation engine for a dynamic human-PCM interaction system, depicting components for processing multimodal human inputs, adapting PCM outputs, maintaining contextual grounding, and ensuring reasoning continuity.

FIG. 4 is a block diagram illustrating an exemplary architecture of an operational learning system for a dynamic human-PCM interaction system, showing components for analyzing interaction patterns, optimizing performance, modeling team dynamics, and generating adaptive modifications.

FIG. 5 is a flow diagram illustrating exemplary multimodal input fusion and conflict resolution within a dynamic human-PCM interaction system, showing how diverse human input modalities may be integrated into coherent prompts for PCM processing.

FIG. 6 is a flow diagram illustrating exemplary task allocation decision processing within a dynamic human-PCM interaction system, showing how tasks may be distributed between human operators and PCM entities through cost optimization and constraint evaluation.

FIG. 7 is a flow diagram illustrating exemplary cognitive load measurement and response adaptation within a dynamic human-PCM interaction system, showing how operator state may be monitored and PCM outputs adapted in real time to match operator capacity.

FIG. 8 is a flow diagram illustrating an exemplary human-to-PCM processing pipeline within a dynamic human-PCM interaction system, showing the transformation of human inputs into PCM reasoning and adapted responses through translation, encoding, reasoning, and output pathways.

FIG. 9 is a flow diagram illustrating an exemplary learning and adaptation cycle within a dynamic human-PCM interaction system, showing how interaction history and performance outcomes may drive continuous improvements to system parameters and cognitive structures.

FIG. 10 is a flow diagram illustrating exemplary operational mode transitions within a dynamic human-PCM interaction system, showing authority allocation shifts between advisory, collaborative, autonomous, and override modes based on trust, load, and error conditions.

FIG. 11 is a flow diagram illustrating exemplary team coordination processing within a dynamic human-PCM interaction system, showing how multi-operator teams may be supported through role assignment, workload balancing, communication monitoring, and collective decision modeling.

FIG. 12 is a flow diagram illustrating exemplary failure recovery processing within a dynamic human-PCM interaction system, showing how system functionality may be maintained through failure detection, safe degradation, and systematic recovery procedures.

FIG. 13 illustrates an exemplary computing environment on which an embodiment described herein may be implemented.

### DETAILED DESCRIPTION OF THE INVENTION

The inventor has conceived and reduced to practice a system and method of dynamic human-PCM interaction modeling in operational environments that enables adaptive collaboration between human operators and persistent cognitive machines. The invention implements mechanisms that continuously adjust cognitive workload distribution, communication modality, and decision-making authority between human and artificial participants to optimize mission performance.

In an embodiment, the system implements four integrated components: a persistent cognitive core, a translation engine, a cognitive load balancer, and an operational learning system. These components operate in coordination to establish a closed-loop framework in which human cognitive state, environmental context, and operational demands directly shape artificial reasoning processes and outputs.

The persistent cognitive core provides domain-specific reasoning capabilities, multi-stage language model processing, and thought caching that preserve both short-term and long-term structures. The core implements cognition as structured trajectories across a latent manifold or equivalent substrate. Reasoning continuity is maintained across extended missions, and processing is modulated in accordance with goal priorities and human cognitive constraints.

The translation engine implements bidirectional interaction between humans and the cognitive core. The engine converts multimodal human inputs—such as voice, gestures, biometric signals, and contextual data—into processable prompts. In the reverse direction, the engine adapts reasoning outputs into human-appropriate formats. Adaptation is based on cognitive state, and may be implemented by selecting levels of detail, selecting output modalities, or adjusting timing of output delivery. For example, when operator workload is elevated, the translation engine outputs concise advisories, whereas when workload is low, the engine outputs richer explanations and contextual detail.

The cognitive load balancer implements continuous monitoring of operator state and allocates tasks accordingly. The balancer computes a composite cognitive load score derived from multiple signals including pupillometry, heart rate variability, gaze distribution, blink rate, galvanic skin response, and response latency. The computation produces a normalized score calibrated to operator baseline values. Based on this score, the balancer allocates tasks to the human operator, to the persistent cognitive machine, or to a shared collaboration mode. Allocation is performed through optimization that balances human cognitive cost, machine confidence, and handoff penalties. The balancer enforces constraints that prevent human overload, limit machine authority to levels supported by trust, and reduce instability from frequent handoffs.

Trust calibration is implemented as a quantitative metric that governs the level of authority granted to the cognitive machine. Trust is computed as a function of accumulated successes, consistency of decisions, recovery from errors, and operator interventions. Trust increases incrementally when autonomous actions are successful and decreases when errors occur or overrides are issued. Time decay ensures that trust is not retained indefinitely in the absence of interaction. The trust metric directly determines whether the system operates in advisory, collaborative, autonomous, or override modes. Mode transitions occur when thresholds are satisfied, and are stabilized by hysteresis bands, minimum duration rules, and cooldown periods. Emergency override conditions immediately return control to the human operator.

The operational learning system implements continuous observation of human-machine interaction and generates adaptations that improve collaboration. The system analyzes operator behavior, decision outcomes, communication rhythms, and error patterns to construct operator-specific and team-specific profiles. From these observations, the learning system generates modifications to authority thresholds, output formatting templates, and reasoning pathways. Adaptations may be implemented by adjusting authority transition thresholds, encoding recurrent strategies into reusable thought structures, or reshaping reasoning manifolds to favor successful pathways. In team contexts, the learning system implements role specialization, workload balancing, and consensus modeling to support multi-operator coordination.

The invention implements resilience mechanisms to maintain functionality under component failures. If the translation engine becomes unavailable, the system outputs raw reasoning chains in simplified form. If the cognitive load balancer fails, the system defaults to a human-in-loop mode with minimal autonomy. If the learning system fails, the system continues using previously validated parameters. If the cognitive core fails, the system alerts the operator and preserves the last known operational state.

The invention further implements distributed adaptation by enabling knowledge structures to be abstracted and shared across multiple persistent cognitive machines. Local adaptations are retained while generalized strategies are federated across deployments. This allows the system to evolve continuously while maintaining operational security and privacy.

Through these coordinated mechanisms, the invention implements a persistent cognitive machine that operates as an adaptive partner. Human cognitive state directly constrains artificial reasoning, outputs are continuously adapted to operator capacity, authority is dynamically modulated based on trust and load, and collaboration improves over time through operational learning.

A cognitive load balancer implements human state monitoring through a composite scoring system that fuses multiple physiological and behavioral signals. In one embodiment, a cognitive load score is computed by weighting and summing normalized values of pupil diameter variance, heart rate variability, gaze distribution, reaction time deviation, blink suppression, and skin conductance peaks. For example, pupil dilation may carry a weight of twenty-five percent, heart rate variability twenty percent, gaze entropy twenty percent, response latency fifteen percent, blink suppression ten percent, and galvanic skin response ten percent. Baseline values are established at mission start, and a sliding integration window with exponential decay weighting produces a continuously updated score between zero and one.

A task allocator assigns work by comparing the projected human cost and machine cost of candidate tasks. Human cost may be defined as the cognitive load score multiplied by expected task duration and an accuracy risk factor. Machine cost may be defined as computational burden multiplied by a confidence factor. The allocator applies dynamic optimization to minimize the combined costs of human effort, machine effort, and handoff penalties, while satisfying constraints such as maintaining human load below eighty-five percent, requiring at least ninety-two percent machine confidence for autonomous action, and limiting handoff frequency to no more than two per minute.

A trust manager quantifies operator confidence in machine autonomy. Trust begins at a base value, such as fifty percent, and increases with successful autonomous decisions, decreases with operator overrides, and decreases more sharply for critical errors requiring intervention. Trust is further shaped by a performance multiplier proportional to the square of correct decision ratios, a consistency factor derived from variation in decision quality, and a recovery bonus when prior errors are successfully corrected. A small time-based decrement prevents obsolete trust values from persisting indefinitely.

An authority manager governs transitions between operational modes. For example, advisory mode is the default state where a machine provides recommendations without execution authority. A transition to collaborative mode occurs when trust exceeds sixty-five percent, cognitive load exceeds sixty percent, and task backlog exceeds a defined threshold. A transition to autonomous mode occurs when trust exceeds eighty percent and either cognitive load exceeds eighty-five percent or an incapacitation condition is detected. A transition to override mode occurs immediately upon receipt of a manual override signal, detection of a critical error, or when trust falls below forty percent. To prevent oscillation, thresholds incorporate hysteresis bands, each mode is maintained for at least thirty seconds unless overridden, and cooldown periods are enforced between transitions.

An operational learning system continuously captures interaction patterns, mission outcomes, and team behaviors to generate adaptations. For example, repeated operator corrections to reasoning outputs lead to modified formatting rules. Frequently successful decision strategies are encoded into reusable reasoning structures. Team-level adaptations may include rebalancing workloads among multiple operators, encoding role specializations, or refining communication templates for collective decision-making. Adaptations are stored persistently and retrieved for future missions, ensuring continuity across operational contexts.

A failure recovery mechanism ensures continued function when components become unavailable. If a translation engine fails, outputs from the reasoning substrate are provided in raw or minimally processed form. If a cognitive load balancer fails, the system defaults to a human-in-loop mode that constrains machine autonomy. If an operational learning system fails, last-known validated parameters are retained to preserve stable operation. If a cognitive core fails, an alert is issued to the human operator and the last known operational state is preserved for manual continuation.

A distributed adaptation mechanism enables multiple persistent cognitive machines to exchange generalized knowledge. In one embodiment, local adaptations such as operator preferences or mission-specific strategies are abstracted into higher-level patterns that are shared across a network of machines. Raw operational data is not exchanged; instead, transferable abstractions are used to preserve security and privacy. This federated learning process allows the collective system to improve continuously while ensuring that sensitive mission details remain compartmentalized.

A team dynamics processor models coordination among multiple operators and one or more persistent cognitive machines. Team composition may be identified by role assignments and historical performance. Cognitive load is monitored for each operator, and imbalances trigger task redistribution toward less burdened team members. Communication patterns are analyzed to identify critical pathways and potential bottlenecks, and collective decision processes are supported by mechanisms such as weighted voting or consensus modeling. Authority boundaries are adjusted to reflect team hierarchy, with higher trust operators or critical roles receiving differentiated authority compared to peripheral participants.

Through these embodiments, a persistent cognitive machine system implements monitoring, task allocation, trust calibration, adaptive authority management, operational learning, failure resilience, distributed adaptation, and team coordination. Together, these mechanisms ensure that a human operator retains decision-making primacy while benefitting from a continuously adapting artificial partner capable of shifting dynamically across advisory, collaborative, and autonomous roles.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “persistent cognitive machine” refers to a computer-implemented cognitive system configured to perform reasoning operations continuously over time, including maintaining, retrieving, or adapting stored thought structures, cached reasoning, or learned interaction patterns.

As used herein, “cognitive core” refers to any processing subsystem of a persistent cognitive machine that generates reasoning outputs using one or more techniques such as language model processing, symbolic reasoning, or structured substrate traversal.

As used herein, “translation engine” refers to any subsystem configured to convert human-generated input into machine-processable representations and to adapt machine-generated output into forms that are comprehensible or actionable by human operators.

As used herein, “multimodal input” refers to any combination of human-generated or environmental signals, including but not limited to voice, text, gesture, eye movement, posture, biometric signals, contextual sensor data, or brain-computer interface signals.

As used herein, “biometric signal” refers to any measurable physiological or behavioral characteristic of a human operator, including but not limited to heart rate variability, pupil dilation, eye movement, blink rate, galvanic skin response, body temperature, or muscle activity.

As used herein, “cognitive load score” refers to any quantitative representation of human operator capacity, mental workload, or attentional resources derived from one or more physiological, behavioral, or contextual indicators.

As used herein, “trust metric” refers to any quantified measure of confidence in machine autonomy or decision-making, derived from performance outcomes, historical consistency, error recovery, operator overrides, or explicit user feedback.

As used herein, “operational mode” refers to any collaboration state governing the relative authority of a human operator and a persistent cognitive machine, including but not limited to advisory, collaborative, autonomous, override, or equivalent states.

As used herein, “reasoning output” refers to any information, conclusion, recommendation, or decision generated by a persistent cognitive machine, regardless of format, modality, or level of detail.

As used herein, “task allocator” refers to any subsystem configured to assign tasks, subtasks, or responsibilities between a human operator and a persistent cognitive machine based on measured or inferred states, including cognitive load, task complexity, or trust conditions.

As used herein, “operational learning system” refers to any subsystem configured to capture interaction history, analyze performance outcomes, identify operator or team patterns, and adapt machine behavior for improved collaboration.

As used herein, “graceful degradation” refers to the continuation of system functionality under partial component failure by reverting to fallback modes such as human-in-loop control, simplified output delivery, or use of stored parameters.

As used herein, “distributed adaptation” refers to the sharing of abstracted patterns, learned strategies, or generalized models across multiple persistent cognitive machines, without transmitting raw or sensitive operational data.

As used herein, “team dynamics processor” refers to any subsystem configured to analyze, balance, or optimize interactions among multiple human operators and one or more persistent cognitive machines, including coordination, workload distribution, communication analysis, and collective decision-making.

As used herein, “real time” refers to responses or adaptations occurring within an interval sufficiently short to support the operational requirements of the environment, which may range from milliseconds to seconds depending on context, and is not limited to instantaneous response.

As used herein, “adaptation” refers to any modification of system behavior, thresholds, representations, or outputs based on prior interactions, context, or state, and is not limited to machine learning or statistical training methods.

As used herein, “multimodal” refers to the use of two or more distinct input or output channels, whether human-generated, machine-generated, or environmental, and is not limited to any specific combination of modalities.

As used herein, “task” refers to any unit of cognitive, computational, or operational work, including subtasks, processes, or actions, and is not limited to human-assigned work items.

### Conceptual Architecture of a Dynamic Human-PCM Interaction System

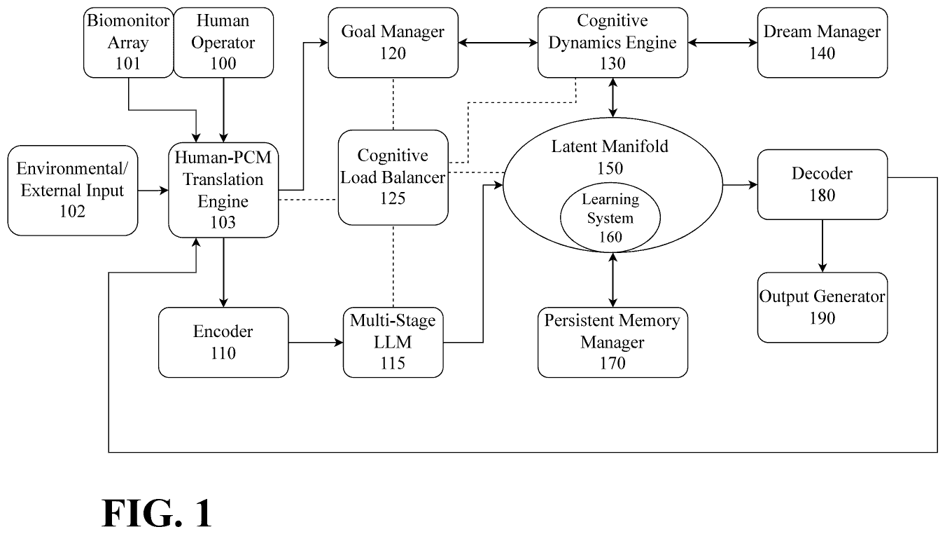

FIG. 1 is a block diagram illustrating an exemplary system architecture for dynamic human-PCM interaction modeling in operational environments, in an embodiment. The system enables adaptive, real-time collaboration between human operators and Persistent Cognitive Machines (PCM) by integrating cognitive load monitoring, bidirectional translation, and continuous learning mechanisms with the geometric cognitive substrate. The architecture fundamentally implements cognition as motion through shaped memory space, where attention follows geodesic paths guided by goal potentials and human cognitive capacity constraints, creating a dynamic partnership that optimizes task allocation based on real-time assessment of human state and operational demands.

In an embodiment, human operator 100 represents field personnel engaged in operational tasks requiring cognitive support. Human operator 100 maintains decision-making primacy while generating continuous streams of multimodal input and physiological data that directly influence system behavior. The operator's cognitive state functions as an active component of the decision space, with fatigue, stress, and cognitive load creating additional fields that shape how the PCM processes information and allocates authority.

A biometric monitor array 101 captures real-time physiological and behavioral signals. These signals may include, for example, pupillometry data for cognitive load assessment, heart rate variability for stress detection, galvanic skin response for arousal monitoring, eye tracking for attention patterns, and response latency measurements. The monitor array 101 applies signal processing such as 60 Hz sampling for eye tracking, 250 Hz sampling for physiological channels, Kalman filtering for artifact removal, and individual baseline calibration during mission initialization. The processed signals are provided to cognitive load balancer 125, which may compute a composite score by weighting and summing multiple normalized physiological and behavioral signals. For example, the score may increase when pupil dilation, stress indicators from heart rate variability, gaze dispersion, slowed reaction times, or suppressed blink rate are detected. This continuous monitoring creates a dynamic representation of human cognitive state that serves as a fundamental constraint on system operations.

A human-PCM translation engine 103 serves as an intelligent bidirectional bridge between human cognition and PCM geometric processing. Translation engine 103 performs multimodal input processing, converting natural language commands, gestures, biometric signals, and contextual cues into PCM-processable prompts enriched with operational metadata. Translation engine 103 may also incorporate environmental or mission-specific inputs such as sensor data or system telemetry, ensuring that PCM reasoning is grounded in both human and environmental context. In the reverse direction, translation engine 103 receives geometric structures from decoder 180 and adapts their presentation based on current cognitive load, selecting appropriate detail levels, modalities, and formats. Translation engine 103 may also maintain state synchronization between the human cognitive context and PCM reasoning state, ensuring continuity across the human-machine boundary. For example, when cognitive load is high, translation engine 103 automatically simplifies PCM outputs into essential information, while during lower-load conditions it provides richer, more detailed responses that enhance situational understanding.

In an embodiment, an encoder 110 implements the mathematical transformation mapping external data from the input space into points within latent manifold 150. Encoder 110 receives context-enriched inputs from translation engine 103, enabling cognitive-load-aware encoding. The encoding process is adaptive, taking into account both the current state of the manifold and the human operator's cognitive capacity. Encoder 110 respects the manifold's metric tensor while considering human-state constraints, embedding inputs in ways that preserve semantic continuity while remaining accessible to the current human-PCM team configuration.

A multi-stage language model 115 functions in conjunction with encoder 110 to generate semantic structures from raw inputs. Unlike conventional stand-alone processors, multi-stage LLM 115 operates as an integrated component within the PCM Core, producing successively refined representations that can be embedded within latent manifold 150. In an embodiment, multi-stage LLM 115 receives additional context about human cognitive state and operational constraints, enabling it to generate thought structures that are both semantically coherent and calibrated to current human-PCM team capacity. For example, under high cognitive load conditions, multi-stage LLM 115 may prioritize essential semantic elements while deferring complex elaborations, creating a cognitive-load-aware processing pipeline.

A goal manager 120 generates and maintains potential fields that shape how attention flows through manifold 150. These potential fields may arise from explicit objectives, operational context, or learned values from prior interactions. Goal manager 120 operates in continuous connection with cognitive load balancer 125, receiving parameters that modulate the potential fields based on human cognitive capacity. For instance, when cognitive load is high, goal manager 120 may generate stronger attractors toward PCM-autonomous regions of manifold 150, routing complex processing away from human-dependent pathways. These modulated potential fields interact with compression pressure fields, creating a dynamic landscape where cognitive load becomes an additional shaping force.

A cognitive load balancer 125 continuously monitors human state and orchestrates dynamic task allocation between human and PCM. Connected to biometric monitor array 101, goal manager 120, and cognitive dynamics engine 130, cognitive load balancer 125 may implement a hierarchical decision process combined with dynamic optimization. In an embodiment, the balancer evaluates candidate task assignments by estimating costs associated with human performance, PCM performance, and the penalties associated with handoffs between them. The allocation decision may be selected to minimize overall cost while maintaining constraints, such as keeping the human operator's cognitive load below a defined threshold value and limiting PCM authority to a level permitted by current trust conditions.

Cognitive load balancer 125 may also maintain trust metrics that represent confidence in PCM autonomy. In an embodiment, the trust metric may be determined by combining a base trust level with factors such as system performance accuracy, consistency of decision-making, and recovery from prior errors. Trust may increase incrementally following successful autonomous operations and may decrease following operator overrides or error conditions. To prevent instability, the balancer may apply stability mechanisms such as hysteresis bands or cooldown periods. Mode transitions between such modes as “advisory”, “collaborative”, “autonomous”, and “override” states may therefore occur only when thresholds are reached in a sustained manner. These adaptive transitions ensure that authority is calibrated to both real-time cognitive load and historical trust evolution.

A cognitive dynamics engine (CDE) 130 serves as the geometric substrate processor and the core architectural element responsible for maintaining and evolving latent manifold 150. In an embodiment, CDE 130 computes geodesic paths through the manifold that represent reasoning trajectories. These paths are determined by considering the manifold's internal connection structure and balancing forces such as compression pressure from semantically dense regions, attraction from goal potentials, and constraints imposed by human cognitive state. CDE 130 also governs the evolution of an attention vector field across the manifold. This process may be modeled as the flow of a fluid that is influenced by gradients of semantic pressure, attraction fields generated by goals, and diffusion terms that prevent over-concentration. Additional modifiers may be applied to reflect human cognitive capacity boundaries, ensuring that the system does not route attention into reasoning paths that would exceed operator capability. In operation, CDE 130 may continuously compute curvature values across manifold 150 to measure semantic density, while dynamically adjusting authority zones. These zones may expand or contract in response to trust scores and cognitive load assessments, thereby constraining which regions of the manifold are available for autonomous PCM processing at any given time.

A dream manager 140 provides autonomous structural reorganization of manifold 150 during off-task or low-demand periods. In an embodiment, dream manager 140 may incorporate operational history from learning system 160, guiding reorganization based on prior human-PCM interaction patterns. During such reorganization, dream manager 140 may perturb previously activated thought bundles by introducing small variations informed by local curvature or uncertainty, effectively testing the stability of those structures. It may also perform recombination operations, blending perturbed bundles into weighted combinations. The resulting blended structures may represent novel abstractions that capture recurring relationships or team-specific reasoning patterns. When these emergent structures are found to be coherent and stable, they may be integrated into manifold 150, thereby enriching the system's capacity for future reasoning and adaptation.

Latent manifold 150 represents the central geometric substrate where cognitive operations occur. Manifold 150 includes fundamental geometric structures such as the metric tensor, connection, Ricci curvature tensor, compression pressure fields, and goal potential fields. In an embodiment, manifold 150 may also contain specialized elements including team-specific thought bundles encoding successful human-PCM interactions, authority zones with variable accessibility based on trust metrics, and cognitive-load-weighted geodesics that preferentially route processing through pathways compatible with current human capacity.

An operational learning system 160 captures human-PCM interaction patterns and builds team-specific adaptations within latent manifold 150. In an embodiment, learning system 160 observes operator preferences, task outcomes, and collaboration sequences, encoding these patterns as specialized thought bundles. These bundles may represent frequently successful reasoning paths or optimized authority distributions. Learning system 160 interacts with persistent memory manager 170 and manifold 150, creating geodesic routes that are reinforced when historically successful and weakened when performance degrades. For example, learning system 160 may adjust manifold curvature in task-related regions, making effective strategies more accessible while increasing resistance in regions associated with problematic decision sequences.

Learning system 160 may further include processors for interaction pattern analysis, performance optimization, and team dynamics modeling. These subsystems enable continuous personalization of PCM responses, adapting to individual operator styles and multi-operator coordination patterns. Through ongoing integration with cognitive load balancer 125, learning system 160 may also refine thresholds for task allocation, adjusting transition points for Advisory, Collaborative, and Autonomous modes based on accumulated trust metrics and operational history.

A persistent memory manager 170 orchestrates long-term storage and retrieval of cognitive structures. In an embodiment, memory manager 170 may preserve thought bundles, established geodesic paths, learned authority boundaries, trust evolution profiles, and cognitive load response patterns. Memory manager 170 may apply thermodynamic-style decay dynamics, which allow natural forgetting of unused structures while retaining information that is frequently accessed or otherwise important. For example, each thought may be assigned an activation energy value that decreases over time when the thought is idle. The rate of decrease may be governed by a decay constant and an inactivity factor, which is high when the thought is unused and low or zero when the thought is active. When the activation energy of a thought falls below a defined threshold, the structure may be pruned from memory. This process ensures efficient use of storage while maintaining access to cognitive structures that contribute to ongoing operations and human-PCM collaboration. In an embodiment, persistent memory manager 170 may also store and retrieve team-specific adaptations generated by operational learning system 160, such as trust-adjusted authority zones or cognitive load calibration profiles. This ensures continuity across missions while allowing adaptation to evolve over extended deployments. Memory manager 170 may further support federated or distributed PCM architectures by preserving abstracted structures that enable knowledge sharing without exposing raw operational data, thereby maintaining privacy and security.

A decoder 180 implements the inverse transformation, converting geometric structures from latent manifold 150 into semantic content that can be communicated externally. Decoder 180 considers both the final manifold positions reached during inference and the geodesic trajectories taken, enabling outputs that reflect reasoning processes rather than just conclusions. In an embodiment, decoder 180 may work in conjunction with multi-stage LLM 115 to generate natural language or symbolic content that preserves semantic continuity with the PCM's internal cognitive state.

An output generator 190 serves as the final stage in the processing pipeline, formatting decoded content for human operator 100 or connected systems. Output generator 190 adapts modality, complexity, and timing in cooperation with translation engine 103, which applies cognitive-load-aware adaptation rules. For example, when cognitive load balancer 125 signals elevated operator fatigue, output generator 190 may suppress nonessential details and present outputs in simplified form. Conversely, during low-load conditions, generator 190 may provide richer multi-modal explanations, including audio, visual, or haptic presentations.

In an embodiment, the architecture of FIG. 1 supports three primary operational pathways. Human operator 100 generates multimodal input (voice, gesture, biometric signals), which are captured through biometric monitor array 101 and processed by translation engine 103. Translation engine 103 enriches inputs with operational context and human state metadata before passing them to encoder 110. Cognitive load balancer 125 concurrently evaluates operator state, providing authority constraints to goal manager 120 and CDE 130. Encoder 110 and multi-stage LLM 115 map the enriched inputs into structures within manifold 150, where attention flows are constrained by goal potentials, compression pressures, and cognitive load boundaries.

CDE 130 computes geodesic trajectories through manifold 150 subject to trust-and load-dependent authority constraints. The resulting structures are provided to decoder 180, which converts geometric reasoning into semantic content. Translation engine 103 and output generator 190 adapt presentation complexity based on real-time CLS values from cognitive load balancer 125, delivering outputs to human operator 100 in formats matched to current capacity.

Operational learning system 160 continuously observes interaction patterns, performance outcomes, and authority transitions. It encodes successful collaborations into specialized thought bundles stored via persistent memory manager 170, modifying manifold 150 to bias future reasoning toward effective strategies. Dream manager 140 may reorganize manifold 150 during off-task periods, consolidating successful patterns and abstracting higher-order strategies. Cognitive load balancer 125 and translation engine 103 receive updated thresholds and adaptation parameters from learning system 160, enabling real-time tuning of authority allocation and output presentation.

Through these pathways, the system of FIG. 1 establishes a closed-loop partnership where human cognitive state directly modulates PCM processing, and PCM outputs are dynamically adapted to human capacity. All components—including encoder 110, LLM 115, goal manager 120, cognitive load balancer 125, CDE 130, dream manager 140, manifold 150, learning system 160, memory manager 170, decoder 180, and output generator 190—operate in synchronized interaction. Information flows as geometric structures shaped not only by task objectives and semantic relationships but also by real-time human state, enabling a persistent cognitive machine that functions as an adaptive partner rather than a static tool.

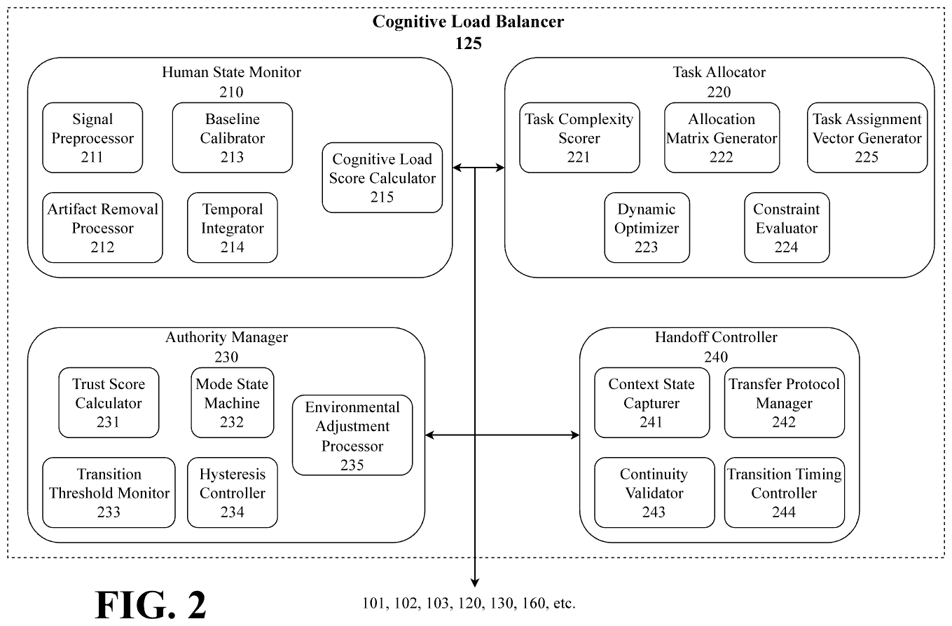

FIG. 2 is a block diagram illustrating an exemplary architecture of a cognitive load balancer 125 for a dynamic human-PCM interaction system, in an embodiment. Cognitive load balancer 125 orchestrates task distribution between human operators and persistent cognitive machine (PCM) systems by monitoring operator cognitive state, computing allocation decisions, managing trust-based authority levels, and coordinating seamless task handoffs during operational activities.

Human state monitor 210 receives multimodal physiological and behavioral signals from biometric monitor array 101. In an embodiment, signal preprocessor 211 applies sampling and filtering operations, including 60 Hz sampling for eye-tracking data and 250 Hz sampling for physiological channels. Artifact removal processor 212 may employ Kalman filtering and statistical outlier rejection beyond three standard deviations from baseline. Baseline calibrator 213 establishes operator-specific reference values during mission initialization, for example using a five-minute resting state calibration. Temporal integrator 214 maintains a sliding thirty-second window with exponential decay weighting to smooth short-term fluctuations. Cognitive load score calculator 215 generates a composite metric by combining normalized indicators such as pupillometry index, heart rate variability, eye fixation entropy, response latency, blink rate suppression, and galvanic skin response amplitude, weighted according to operational needs (for example, pupillometry 0.25, HRV 0.20, eye fixation entropy 0.20, response latency 0.15, blink suppression 0.10, and GSR 0.10). In other embodiments, additional physiological or behavioral signals may be incorporated and alternative weighting schemes may be applied. The resulting cognitive load score is provided to task allocator 220 and authority manager 230.

Task allocator 220 determines distribution of cognitive tasks between human and PCM entities. Task complexity scorer 221 evaluates pending tasks according to factors including time criticality (e.g., deadline in seconds), information density (e.g., bits per decision), consequence severity (e.g., mission impact on a normalized scale), and uncertainty level (e.g., statistical confidence intervals). Allocation matrix generator 222 constructs cost models for human and PCM performance, with human cost computed as a function of cognitive load score, task duration, and expected accuracy, and PCM cost computed from computational load and confidence factors. Dynamic optimizer 223 applies decision-tree analysis with dynamic programming to minimize total cost, accounting for human and PCM performance and handoff penalties. Constraint evaluator 224 verifies that allocations satisfy operational requirements, such as maintaining human load below a critical threshold (e.g., 0.85), ensuring PCM confidence exceeds a defined minimum (e.g., 0.92) for autonomous execution, and limiting handoff frequency (e.g., maximum of two per minute). Task assignment vector generator 225 outputs allocation decisions for execution by handoff controller 240 and for integration into PCM processing pathways.

Authority manager 230 governs PCM autonomy based on trust metrics and operational context. Trust score calculator 231 maintains a dynamic trust score starting from a base value (e.g., 0.5) and incrementally adjusting upward or downward based on outcomes, including successful autonomous decisions, operator overrides, decision consistency, and error recoveries. Mode state machine 232 governs transitions between advisory, collaborative, autonomous, and override operational modes. Transition threshold monitor 233 evaluates real-time trust and load conditions, for example enabling transitions from advisory to collaborative mode when trust exceeds 0.65, load exceeds 0.60, and more than three tasks are queued. Hysteresis controller 234 mitigates mode oscillation through threshold bands, minimum duration rules, and cooldown periods. Environmental adjustment processor 235 adapts thresholds for operator-specific calibration or degraded sensor conditions. Authority parameters are provided to goal manager 120 and cognitive dynamics engine 130 to constrain PCM processing.

Handoff controller 240 coordinates transfer of task responsibility between human and PCM. Context state capturer 241 records task state, including progress and reasoning chains, at transfer initiation. Transfer protocol manager 242 manages the timing of handoffs, implementing rapid (<50 ms) transfers for emergencies, intermediate transfers (~200 ms) for urgent shifts, and gradual (~2 s) transfers for planned authority increases. Continuity validator 243 confirms that the receiving entity has successfully assumed responsibility through state synchronization and capability checks. Transition timing controller 244 regulates temporal characteristics of handoffs to ensure stability. Metadata from handoffs may be provided to operational learning system 160 for optimization of future transitions.

Cognitive load balancer 125 maintains bidirectional connections with translation engine 103, exchanging operator capacity assessments and recommended interaction complexity levels. Interfaces with PCM core components provide access to reasoning load and confidence data while delivering task allocation and authority parameters. Cognitive load balancer 125 further communicates with operational learning system 160, which receives trust and performance data and provides updated thresholds and adaptation parameters.

Through these interconnections, cognitive load balancer 125 provides real-time monitoring, task allocation, trust-based authority management, and seamless task transitions, enabling adaptive human-PCM teaming under varying operational demands.

In operation, data flows through cognitive load balancer 125 along interconnected pathways linking human state assessment, task allocation, authority management, and task handoff functions. Physiological and behavioral signals from biometric monitor array 101 are received by human state monitor 210, processed into composite cognitive load scores, and transmitted to task allocator 220 and authority manager 230. Task allocator 220 integrates these scores with task complexity metrics to generate allocation decisions, which are provided to handoff controller 240 for execution and to PCM core pathways for integration into reasoning processes. Authority manager 230 combines cognitive load scores with trust metrics to determine both autonomy boundaries and operational mode transitions. Transition signals generated by mode state machine 232 (for example, transitions between advisory, collaborative, autonomous, and override modes) are transmitted to goal manager 120 and cognitive dynamics engine 130 to constrain PCM processing within permitted authority levels. These mode signals are also communicated to translation engine 103 to ensure output formatting aligns with the current collaboration state, and to operational learning system 160 for long-term adaptation of thresholds and transition conditions. Handoff controller 240 coordinates context transfers during mode changes or task reassignments, verifying synchronization and transmitting metadata to learning system 160. Collectively, these pathways create a closed-loop system where human cognitive state directly governs task allocation, trust-based authority levels, and dynamic mode transitions, enabling adaptive calibration of PCM behavior in real time.

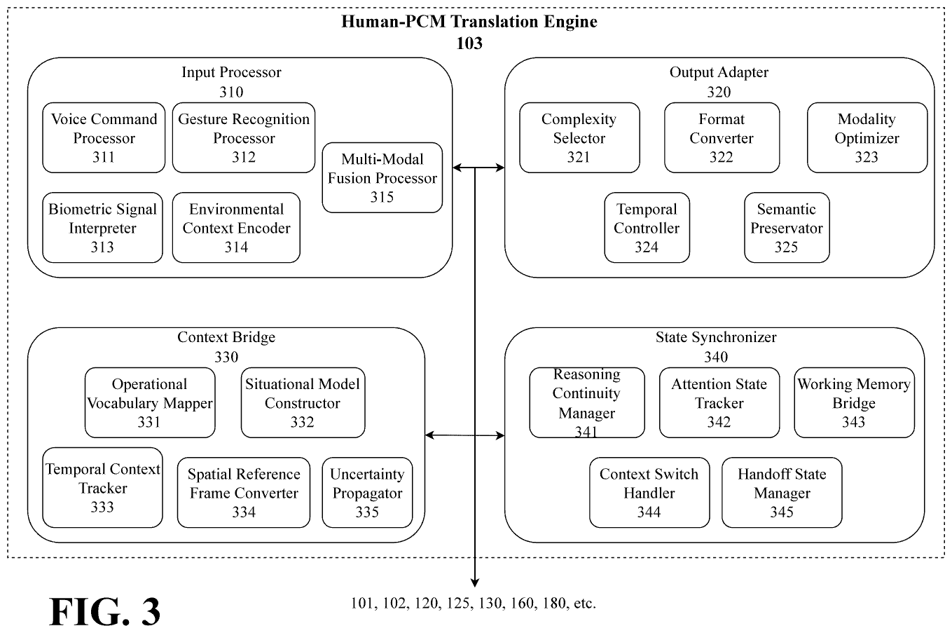

FIG. 3 is a block diagram illustrating an exemplary architecture of human-PCM translation engine 103 for a dynamic human-PCM interaction system, in an embodiment. Translation engine 103 functions as a bidirectional interface between human cognitive processes and PCM reasoning, converting multimodal human inputs into PCM-processable representations while adapting PCM outputs to operator state and mission context.

Input processor 310 receives human-generated signals across multiple modalities and transforms them into unified input structures. Voice command processor 311 applies speech recognition and semantic parsing to natural language utterances, extracting intent, parameters, and contextual qualifiers. Gesture recognition processor 312 interprets physical movements using spatial tracking and pattern matching against operational gesture vocabularies. Biometric signal interpreter 313 processes physiological indicators such as stress markers, arousal levels, and attention cues to provide implicit operator state information. Environmental context encoder 314 integrates mission parameters, sensor data, and situational awareness feeds. Multimodal fusion processor 315 combines outputs of processors 311-314, resolving conflicts and reinforcing patterns across modalities. In some embodiments, additional input modalities such as gaze tracking, tactile input, or brain-computer interface signals may be incorporated. The resulting enriched input structures are transmitted to encoder 110 along with contextual metadata.

Output adapter 320 transforms PCM reasoning structures into operator-appropriate presentations. Complexity selector 321 adjusts detail levels according to cognitive load scores from cognitive load balancer 125, ranging from concise summaries under high load to comprehensive explanations during low load. Format converter 322 translates geometric structures from decoder 180 into interpretable outputs such as natural language narratives, visual diagrams, tabular data, or symbolic notations. Modality optimizer 323 selects sensory channels—visual, auditory, or haptic—based on information type and operator preference. Temporal controller 324 regulates information flow, providing progressive disclosure for complex outputs and buffering non-critical data during high-tempo operations. Semantic preservator 325 maintains fidelity to PCM reasoning while removing artifacts of geometric processing. Adapted outputs are passed to output generator 190 for final presentation.

Context bridge 330 grounds input and output processes in operational context. Operational vocabulary mapper 331 maintains bidirectional mappings between domain-specific terminology and PCM semantic structures. Situational model constructor 332 builds contextual representations including mission objectives, resource status, threat assessments, and team composition. Temporal context tracker 333 monitors mission phases and time dependencies, while spatial reference frame converter 334 manages coordinate transformations between human-centric references and PCM representations. Uncertainty propagator 335 preserves confidence measures, ensuring that PCM outputs reflect reliability assessments and PCM processes incorporate uncertainty from human inputs. Context bridge 330 continuously exchanges data with input processor 310 and output adapter 320 to maintain situational grounding.

State synchronizer 340 preserves continuity across extended human-PCM interactions. Reasoning continuity manager 341 tracks conversation history, assumptions, and evidence to enable multi-turn interactions. Attention state tracker 342 monitors human and PCM focus, flagging divergence in cognitive attention. Working memory bridge 343 provides shared temporary storage for intermediate results and pending decisions. Context switch handler 344 manages transitions between mission phases, retaining relevant information while clearing obsolete state. Handoff state manager 345 coordinates with handoff controller 240 in cognitive load balancer 125 to support authority transitions, packaging state data for seamless task transfer. State synchronizer 340 exchanges vectors with cognitive dynamics engine 130 to maintain coherent reasoning context.

Translation engine 103 maintains connections with other subsystems for adaptive operation. Cognitive load balancer 125 supplies real-time cognitive capacity assessments to output adapter 320 and temporal controller 324. Encoder 110 and decoder 180 provide bidirectional exchange between enriched prompts and geometric reasoning structures. Goal manager 120 communicates current objectives and priorities, guiding contextual emphasis. Operational learning system 160 supplies historical adaptation patterns for operator- and mission-specific optimization.

Data flows through translation engine 103 follow distinct pathways for input and output processing, unified through context bridge 330 and state synchronizer 340. Human inputs pass through input processor 310 and are enriched with contextual data before reaching encoder 110. PCM outputs are adapted in output adapter 320, informed by cognitive load conditions and grounded by context bridge 330, before delivery to output generator 190. State synchronizer 340 ensures continuity and alignment with cognitive dynamics engine 130. Through these pathways, translation engine 103 preserves semantic fidelity while adapting presentation to operator cognitive capacity, enabling effective human-PCM collaboration across diverse operational conditions.

Data flow through translation engine 103 proceeds along bidirectional input and output pathways. On the input side, human multimodal signals including voice, gesture, biometric indicators, and contextual data are received by input processor 310, fused into enriched prompts, and transmitted to encoder 110 for geometric processing. Context bridge 330 supplements these prompts with mission state, vocabulary mappings, and temporal-spatial references, while state synchronizer 340 ensures continuity with prior interactions by providing shared state vectors. On the output side, reasoning structures produced by decoder 180 are received by output adapter 320, where cognitive load-based complexity selection, format conversion, modality optimization, and temporal pacing are applied. Context bridge 330 supplies operational grounding, and state synchronizer 340 aligns output content with accumulated context before adapted outputs are delivered to output generator 190 for presentation to human operator 100. Throughout this cycle, translation engine 103 exchanges signals with cognitive load balancer 125, goal manager 120, and operational learning system 160, enabling adaptation of translations to real-time operator state and mission requirements.

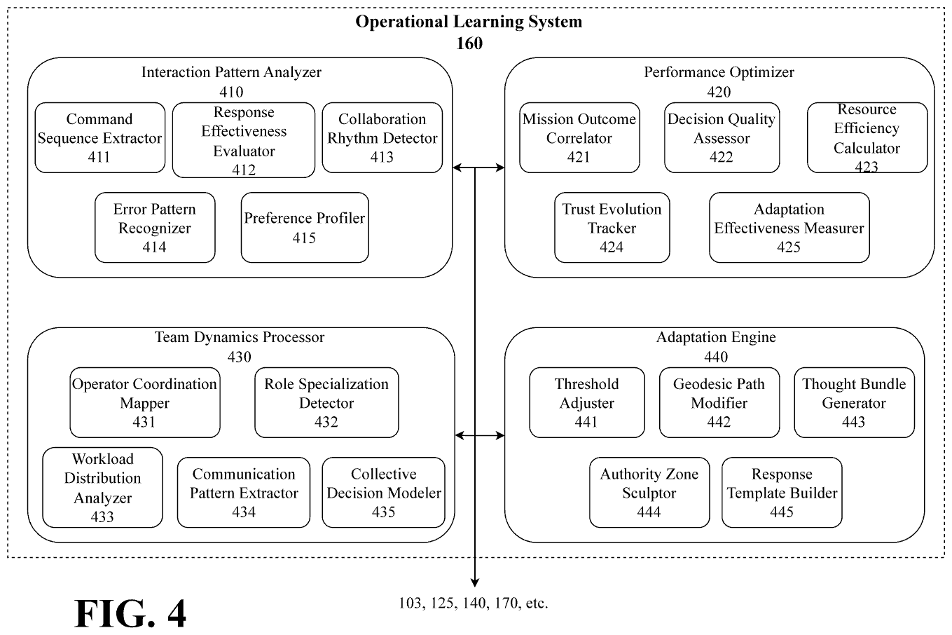

FIG. 4 is a block diagram illustrating an exemplary architecture of operational learning system 160 for a dynamic human-PCM interaction system, in an embodiment. Operational learning system 160 captures human-PCM interaction patterns, optimizes collaborative performance, and generates operator-or team-specific adaptations within latent manifold 150 through continuous observation, correlation, and refinement.

Interaction pattern analyzer 410 identifies recurring operator behaviors and preferences from ongoing exchanges. Command sequence extractor 411 processes input streams from translation engine 103 to detect common phrasing, command sequences, and task ordering preferences. Response effectiveness evaluator 412 measures operator engagement with PCM outputs, for example by tracking acceptance rates, overrides, and decision times. Collaboration rhythm detector 413 identifies temporal patterns such as pacing, pause points, or recovery periods. Error pattern recognizer 414 analyzes intervention events, extracting precursor conditions for system misalignment. Preference profiler 415 models operator tendencies including risk tolerance, detail level preferences, and decision strategies under varying cognitive loads. Outputs from analyzer 410 are provided to performance optimizer 420 and adaptation engine 440.

Performance optimizer 420 correlates operational outcomes with interaction patterns to identify effective strategies. Mission outcome correlator 421 links specific collaboration styles to mission success metrics. Decision quality assessor 422 compares human-PCM joint outcomes against optimal or expert benchmarks. Resource efficiency calculator 423 evaluates cognitive and computational cost trade-offs to minimize operator burden while maintaining mission effectiveness. Trust evolution tracker 424 monitors operator confidence in PCM capabilities over time and associates changes with specific events. Adaptation effectiveness measurer 425 quantifies improvements achieved from prior learning cycles. In some embodiments, additional evaluators such as stress-recovery monitors or variance trackers may be employed. Optimization parameters are communicated to cognitive load balancer 125, while manifold modifications are transmitted to persistent memory manager 170.

Team dynamics processor 430 models multi-operator collaboration with one or more PCM systems. Operator coordination mapper 431 identifies communication protocols and leadership structures. Role specialization detector 432 captures division of responsibilities across team members. Workload distribution analyzer 433 measures shifts in cognitive demand and identifies imbalance. Communication pattern extractor 434 evaluates inter-operator messaging to detect critical communication paths and bottlenecks. Collective decision modeler 435 captures consensus-building dynamics such as voting behavior, influence factors, or conflict resolution strategies. Team-specific parameters are provided to goal manager 120 and authority allocation guidelines are transmitted to cognitive load balancer 125.

Adaptation engine 440 synthesizes observations into system modifications. Threshold adjuster 441 modifies authority transition points, load limits, and trust boundaries based on historical performance. Geodesic path modifier 442 strengthens successful reasoning trajectories in manifold 150 and increases resistance along problematic routes. Thought bundle generator 443 encodes recurring solutions into reusable cognitive structures. Authority zone sculptor 444 reshapes regions of autonomous operation within manifold 150 according to operator trust and task domain performance. Response template builder 445 creates operator-specific formatting rules for outputs, aligning with observed comprehension styles. Adaptation engine 440 transmits manifold updates to cognitive dynamics engine 130 and response template updates to translation engine 103.

Operational learning system 160 interfaces with cognitive load balancer 125 for continuous streams of operator state and authority transition data, with translation engine 103 for interaction logs, with persistent memory manager 170 for long-term storage and retrieval of learned structures, and with dream manager 140 for off-task reorganization.

Data flows through system 160 along multiple pipelines. Interaction logs enter analyzer 410, performance metrics enter optimizer 420, and team communications enter processor 430. Outputs converge in adaptation engine 440, which generates updates including threshold parameters to load balancer 125, manifold modifications to dynamics engine 130, and formatting templates to translation engine 103.

Learning operates on multiple time horizons. Short-term adaptations adjust response formatting during missions. Medium-term learning spans across missions to refine authority thresholds and allocation strategies. Long-term evolution builds team-specific coordination models and reshapes manifold structures. In other embodiments, federated or distributed training may be employed across multiple deployments.

Operational learning system 160 thereby transforms accumulated interaction history into adaptive system modifications, enabling PCM systems to evolve as effective partners over time while retaining flexibility to accommodate new operators, diverse mission conditions, and changing operational environments.

Data flows through operational learning system 160 along concurrent analysis and adaptation pipelines. Interaction logs and operator command streams from translation engine 103 are processed by interaction pattern analyzer 410, while performance metrics from completed operations are evaluated by performance optimizer 420. In multi-operator scenarios, communication data and coordination events are examined by team dynamics processor 430. Outputs from analyzers 410, 420, and 430 converge in adaptation engine 440, which synthesizes observations into concrete system modifications including threshold adjustments, manifold reconfigurations, and response template updates. These modifications are transmitted to cognitive load balancer 125, cognitive dynamics engine 130, translation engine 103, and persistent memory manager 170 for implementation and long-term storage. Feedback loops operate across multiple time horizons: immediate adjustments during missions, aggregated refinements across missions, and long-term evolution of team dynamics. These pathways ensure that operational learning system 160 continuously integrates historical experience with real-time observations to improve human-PCM collaboration.

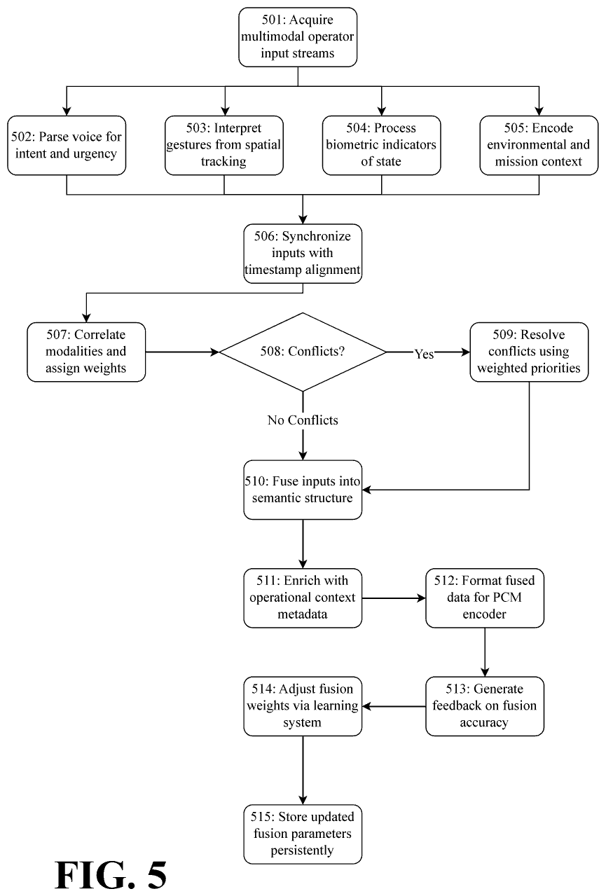

FIG. 5 is a flow diagram illustrating exemplary multimodal input fusion and conflict resolution within a dynamic human-PCM interaction system, in an embodiment. The process enables translation engine 103 to synthesize diverse human input modalities into unified, enriched prompts for PCM processing while maintaining semantic coherence and resolving inter-modal contradictions through confidence-weighted prioritization.

The process begins when input processor 310 initiates multimodal data acquisition from human operator 100, capturing concurrent streams of voice commands, physical gestures, physiological signals, and environmental context data through integrated sensors and interfaces 501.

Voice command processor 311 receives natural language utterances through acoustic sensors, applying speech recognition and semantic parsing to extract intent parameters, command structures, and prosodic indicators that may signal urgency, uncertainty, or emotional state 502.

Gesture recognition processor 312 simultaneously captures physical movements through spatial tracking systems, interpreting hand positions, body posture, and motion trajectories against operational gesture vocabularies to identify command gestures, pointing references, or emphasis indicators 503.

Biometric signal interpreter 313 processes continuous physiological data streams including pupillometry, heart rate variability, galvanic skin response, and eye tracking patterns to derive implicit operator state information such as stress levels, cognitive load, and attention focus that provide context for explicit commands 504.

Environmental context encoder 314 integrates mission-specific parameters including current operational phase, threat assessments, resource availability, sensor feeds, and team coordination status to establish situational grounding for human inputs 505.

Temporal context tracker 333 within context bridge 330 receives the multiple asynchronous input streams and synchronizes them using timestamp correlation and interpolation, establishing a unified temporal framework where events across different modalities can be accurately correlated despite varying sampling rates and processing latencies 506.

State synchronizer 340 through attention state tracker 342 performs cross-modal correlation analysis on the aligned signals, identifying reinforcing patterns across modalities such as voice commands coinciding with confirming gestures or stress indicators aligning with urgent vocal prosody, establishing confidence weights for each input channel based on internal consistency and signal quality metrics 507.

Context switch handler 344 within state synchronizer 340 evaluates the correlated inputs to identify contradictions between modalities, such as a cancellation gesture occurring during a voice command or biometric indicators suggesting high stress while verbal communication remains calm, flagging these discrepancies for resolution 508.

When conflicts are detected, uncertainty propagator 335 within context bridge 330 may further apply a hierarchical resolution framework that considers signal reliability, operational context, and historical accuracy of each modality for the current operator, computing weighted confidence scores that determine which modal input takes precedence while preserving minority signals as metadata for downstream processing 509.

Multimodal fusion processor 315 receives the resolved and weighted inputs from the various processors and integrates them into a unified semantic structure, combining explicit commands from voice and gesture channels with implicit state information from biometric and environmental streams to create a comprehensive representation of operator intent and context 510.

Operational vocabulary mapper 331 and situational model constructor 332 within context bridge 330 augment the fused input with mission-critical contextual information including temporal constraints, authority levels, resource limitations, and coordination requirements that may not be explicitly present in the raw human inputs but are essential for appropriate PCM processing 511.

Spatial reference frame converter 334 within context bridge 330 may further transform the fused and annotated multimodal data into a structured format compatible with encoder 110, maintaining semantic fidelity while organizing information according to PCM architectural requirements and preserving uncertainty measures and confidence indicators from the fusion process 512.

Reasoning continuity manager 341 within state synchronizer 340 monitors the effectiveness of generated prompts by tracking PCM interpretation accuracy, operator corrections, task outcomes, and response appropriateness, creating a feedback signal that quantifies how well the fusion process captured actual operator intent 513.

Command sequence extractor 411 within interaction pattern analyzer 410 receives the feedback data and processes accumulated feedback to identify patterns that should modify the confidence weights and priority rules applied during multimodal fusion, implementing gradient-based optimization to improve future fusion accuracy for specific operators, operational contexts, and input combinations 514.

Response template builder 445 within adaptation engine 440 generates updated fusion parameters including adjusted weights, learned conflict resolution patterns, and operator-specific calibrations, which are then stored by persistent memory manager 170, ensuring that improvements in multimodal fusion persist across sessions and can be retrieved for similar operational contexts 515.

Through this systematic fusion and conflict resolution process, distributed across specialized components of translation engine 103 and coordinated with operational learning system 160, the system may transform potentially contradictory or incomplete multimodal human inputs into coherent, context-rich prompts that accurately represent operator intent while preserving important metadata about confidence, urgency, and cognitive state.

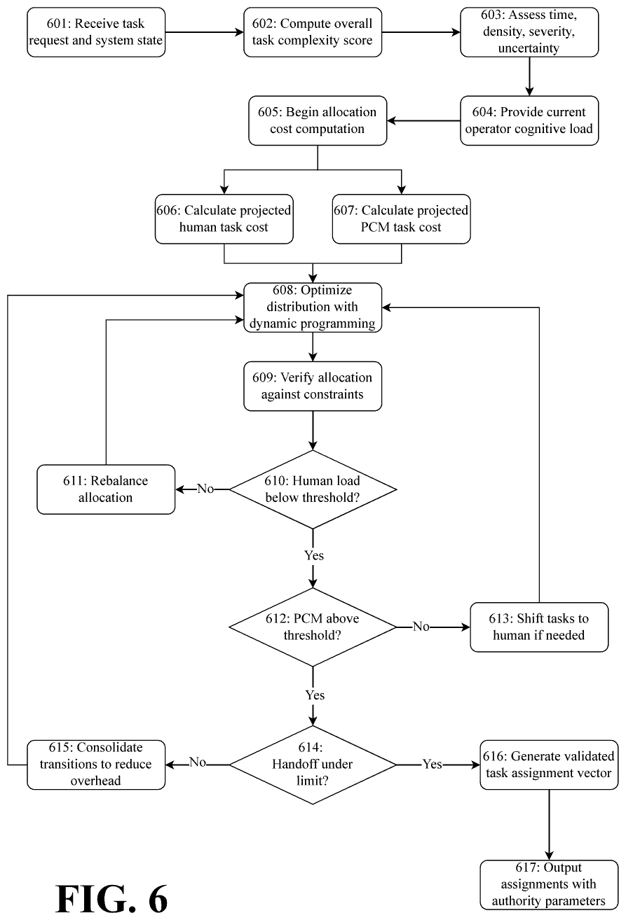

FIG. 6 is a flow diagram illustrating exemplary task allocation decision processing within a dynamic human-PCM interaction system, in an embodiment. The process enables cognitive load balancer 125 to dynamically distribute cognitive tasks between human operators and PCM systems through cost optimization while maintaining operational constraints and performance requirements.

The process may begin when task allocator 220 receives a new task request along with current system state information including operator status, PCM availability, and mission context from translation engine 103 and PCM core components 601.

Task complexity scorer 221 analyzes the incoming task to compute a task complexity score by evaluating multiple dimensional factors that may determine processing requirements and criticality 602.

Task complexity scorer 221 may evaluate time criticality by calculating seconds remaining until task deadline, information density by measuring bits per decision required, consequence severity through normalized mission impact assessment ranging from zero to one, and uncertainty level through statistical confidence intervals of available data 603.

Cognitive load score calculator 215 within human state monitor 210 may concurrently provide the current cognitive load score for human operator 100, computed from the weighted combination of physiological and behavioral indicators as established through biometric monitor array 101 604.

Allocation matrix generator 222 receives the task complexity score and cognitive load score to begin computing allocation costs for potential task distributions between human and PCM entities 605.

Allocation matrix generator 222 may calculate the human cost component by multiplying the cognitive load score by estimated task duration and accuracy risk factor, producing a quantified measure of projected human cognitive burden for the specific task 606.

Allocation matrix generator 222 may also calculate the PCM cost component by multiplying computational load requirements by a confidence factor inversely related to PCM certainty for the task domain, establishing the system resource cost for autonomous execution 607.

Dynamic optimizer 223 receives both human and PCM cost calculations along with any pending task queue information to begin optimization processing, for example using dynamic programming techniques to minimize total operational cost 608.

Constraint evaluator 224 examines the proposed allocation from dynamic optimizer 223 against operational constraints to verify feasibility and safety of the distribution 609.

Constraint evaluator 224 may evaluate whether the proposed human cognitive load would remain below a critical threshold (for example 0.85 on a normalized scale), thereby helping to protect operator 100 from cognitive overload 610.

When human load would exceed the threshold, constraint evaluator 224 may signal dynamic optimizer 223 to rebalance the allocation by shifting additional tasks to PCM processing, triggering a new optimization iteration with adjusted constraints 611.

When human load remains acceptable, constraint evaluator 224 may evaluate whether PCM confidence for autonomous execution meets or exceeds a minimum threshold (for example 0.92), thereby ensuring sufficient reliability for tasks allocated to autonomous processing 612.

When PCM confidence falls below the threshold for proposed autonomous tasks, constraint evaluator 224 may direct dynamic optimizer 223 to increase human allocation for those specific tasks, maintaining operational safety through human oversight of uncertain decisions 613.

When PCM confidence meets requirements, constraint evaluator 224 may evaluate the proposed handoff frequency to ensure it remains below a defined limit (for example, two transitions per minute), reducing the risk of thrashing between human and PCM that could disrupt operational flow 614.

When handoff rate would exceed the limit, constraint evaluator 224 may instruct dynamic optimizer 223 to consolidate task transitions, such as batching related tasks together to reduce context-switching overhead for both human and PCM 615.

Task assignment vector generator 225 may then receive the validated and optimized allocation from constraint evaluator 224 and generate a task assignment vector specifying which entity handles each subtask along with temporal sequencing and authority levels 616.

Task assignment vector generator 225 may output the allocation decision including task assignments to human or PCM, scheduled handoff points with context transfer requirements, and authority parameters that bound PCM autonomy levels. This information may be transmitted to handoff controller 240, authority manager 230, and translation engine 103 for execution 617.

Through this systematic evaluation and optimization process, cognitive load balancer 125 may allocate tasks between human and PCM in a manner that supports operational effectiveness while managing human cognitive capacity and maintaining safety constraints.

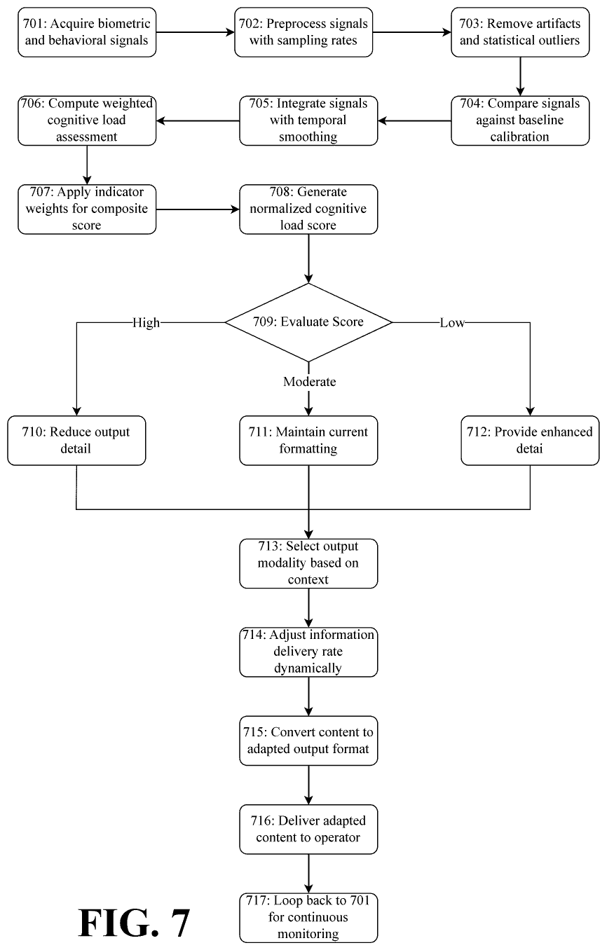

FIG. 7 is a flow diagram illustrating exemplary cognitive load measurement and response adaptation within a dynamic human-PCM interaction system, in an embodiment. The process may enable continuous monitoring of human operator cognitive state and real-time adjustment of PCM output complexity to align with operator capacity, supporting effective communication while reducing the likelihood of cognitive overload.

The process may begin when biometric monitor array 101 acquires physiological and behavioral signals from human operator 100, capturing concurrent data streams including eye movements, cardiac activity, skin conductance, and behavioral responses 701.

Signal preprocessor 211 within human state monitor 210 may receive the raw signals and apply appropriate sampling rates, for example processing eye tracking data at 60 Hz to capture saccades and fixations while sampling physiological channels at 250 Hz to preserve heart rate variability and other rapid physiological changes 702.

Artifact removal processor 212 may apply Kalman filtering algorithms to the preprocessed signals, removing movement artifacts, electrical interference, and statistical outliers that exceed three standard deviations from the established baseline to improve signal integrity 703.

Baseline calibrator 213 may compare the filtered signals against operator-specific reference values established during a five-minute resting state calibration performed at mission initialization, enabling detection of meaningful deviations from individual normal ranges 704.

Temporal integrator 214 may process the calibrated signals through a thirty-second sliding window with exponential decay weighting, smoothing short-term fluctuations while preserving meaningful trends in cognitive load indicators 705.

Cognitive load score calculator 215 may then receive the temporally integrated signals and compute a weighted combination of multiple normalized indicators to generate a composite cognitive load assessment 706.

In one embodiment, the calculator applies specific weights to each indicator component including pupillometry index at 0.25 measuring pupil diameter variance from baseline, heart rate variability stress metric at 0.20 using root mean square of successive differences, eye fixation entropy at 0.20 quantifying spatial distribution of gaze patterns, response latency at 0.15 tracking deviation from baseline reaction times, blink rate suppression at 0.10 detecting reduction from normal patterns, and galvanic skin response amplitude at 0.10 measuring skin conductance peaks per minute 707.

Cognitive load score calculator 215 may generate the composite cognitive load score by summing the weighted normalized indicators, producing a value between zero and one that represents current operator cognitive burden 708.

The system may evaluate the composite score against established thresholds to determine appropriate response adaptation strategies 709.

For example, when cognitive load exceeds 0.70, indicating high operator burden for output adaptation purposes (distinct from the higher 0.85 threshold used for allocation safety), complexity selector 321 within output adapter 320 may reduce the detail level of PCM outputs to essential information, omitting elaborative explanations and auxiliary data 710.

When cognitive load falls between 0.40 and 0.70, the system may maintain current output formatting without modification, preserving the established level of detail 711.

When cognitive load remains below 0.40, the system may increase detail by providing enhanced explanations, additional context, and reasoning chains to improve operator understanding and decision-making 712.

Modality optimizer 323 may receive the complexity-adjusted content and select an appropriate sensory channel for information delivery based on cognitive load level and information type, such as visual displays for spatial data, auditory channels for alerts, or haptic feedback for urgent signals 713.

Temporal controller 324 may adjust the information delivery rate based on current cognitive load, slowing presentation during high-load conditions to reduce operator burden while accelerating during low-load periods to maintain engagement 714.

Format converter 322 may apply the determined adaptations to transform PCM outputs into the selected modality and complexity level, preserving semantic fidelity while matching presentation to operator capacity 715.

Output generator 190 may deliver the adapted content to human operator 100 through the selected channel at the adjusted temporal rate, completing the adaptation cycle 716.

The system may maintain continuous monitoring by returning to biometric signal acquisition, creating a closed-loop process that dynamically adjusts PCM outputs in real time as operator cognitive load fluctuates throughout the mission 717.

Through this continuous measurement and adaptation cycle, the system may present information in formats and at rates compatible with current operator capacity, thereby supporting comprehension and decision-making while reducing the likelihood of cognitive overload that could compromise performance.

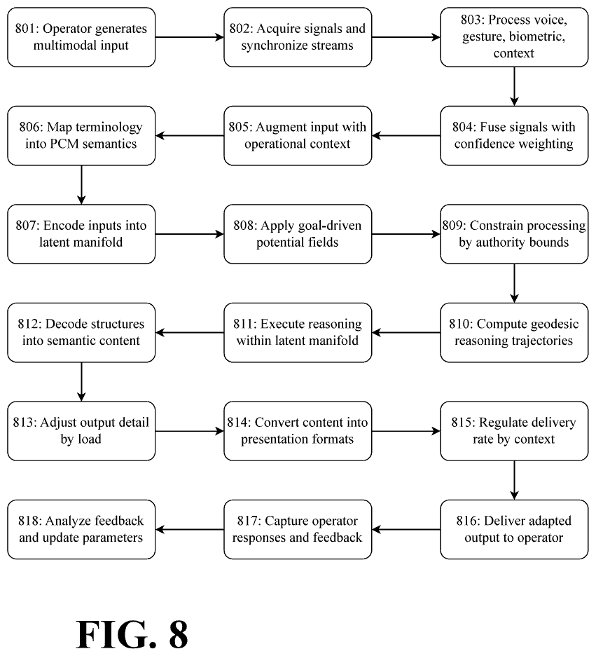

FIG. 8 is a flow diagram illustrating an exemplary human-to-PCM processing pipeline within a dynamic human-PCM interaction system, in an embodiment. The process may trace the transformation pathway from multimodal human input through geometric cognitive processing to adapted output delivery, demonstrating how human inputs may be enriched, processed within authority constraints, and returned as cognitively-appropriate responses.

The process may begin when human operator 100 generates multimodal input through natural language commands, physical gestures, physiological responses, or combinations thereof during operational activities 801.

Input processor 310 within translation engine 103 may acquire the diverse signal streams through connected sensors and interfaces, establishing temporal synchronization markers for correlation across modalities 802.

Voice command processor 311, gesture recognition processor 312, biometric signal interpreter 313, and environmental context encoder 314 may process their respective signal types in parallel, extracting semantic content, intent indicators, state information, and contextual parameters from each modality 803.

Multimodal fusion processor 315 may receive the processed signals from individual modality processors and integrate them into a unified input representation, resolving conflicts through confidence weighting while preserving uncertainty indicators and metadata from each source 804.

Context bridge 330 may augment the fused input with operational context including mission phase, resource constraints, threat assessments, and coordination requirements that provide additional grounding for PCM processing 805.

Operational vocabulary mapper 331 within context bridge 330 may translate domain-specific terminology and operational concepts into PCM-compatible semantic structures, maintaining bidirectional mappings for consistent interpretation 806.

Encoder 110 may receive the context-enriched multimodal input and map it into geometric structures within latent manifold 150, preserving semantic relationships while transforming human-centric representations into the PCM's geometric cognitive substrate 807.

Goal manager 120 may apply potential fields to the encoded structures based on current objectives, operational priorities, and mission constraints, creating gradients that influence attention flow through the manifold 808.

Cognitive load balancer 125 may evaluate current operator cognitive state and determine authority bounds for PCM processing, constraining the regions of latent manifold 150 accessible for autonomous reasoning based on trust metrics and cognitive load scores 809.

Cognitive dynamics engine 130 may compute geodesic paths through the authorized regions of latent manifold 150, following gradients established by goal potentials while respecting curvature constraints that encode semantic relationships and authority boundaries 810.

Latent manifold 150 may represent the reasoning process as attention flows along computed geodesics, activating thought bundles and forming new connections that represent PCM cognitive processing of the human input within authority constraints 811.

Decoder 180 may extract the resulting geometric structures from latent manifold 150 and begin transformation back into semantic content, preserving both conclusions and reasoning trajectories that contributed to those conclusions 812.

Complexity selector 321 within output adapter 320 may receive the decoded content and current cognitive load score from cognitive load balancer 125, adjusting the level of detail from comprehensive explanations during lower load conditions to essential information during higher load conditions 813.

Format converter 322 may transform the complexity-adjusted content into appropriate presentation formats, selecting between natural language narratives, visual diagrams, tabular data, or symbolic notations based on information type and operator preferences 814.

Temporal controller 324 may regulate the information flow rate based on current cognitive load and operational tempo, for example implementing progressive disclosure for complex outputs while buffering non-critical information during higher-stress periods 815.

Output generator 190 may deliver the formatted and temporally regulated response to human operator 100 through selected sensory channels, completing the processing pipeline from input to output 816.

State synchronizer 340 may capture operator response to PCM output including acceptance indicators, correction actions, or clarification requests, creating feedback signals that may be used to assess interpretation accuracy and response effectiveness 817.

Operational learning system 160 may receive the feedback data along with complete interaction logs, analyzing patterns through interaction pattern analyzer 410 and performance optimizer 420 to identify successful strategies and areas for adaptation, generating parameter updates that may improve future human-PCM interactions 818.

Through this processing pipeline, the system may transform multimodal human inputs into contextually appropriate, cognitively adapted responses, while supporting continuous learning from interaction outcomes to enhance effectiveness of the human-PCM partnership.

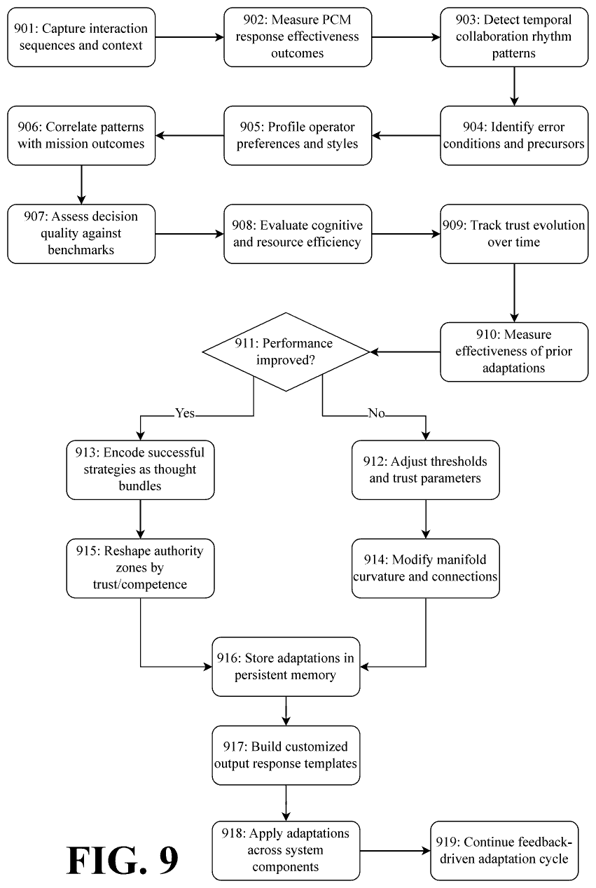

FIG. 9 is a flow diagram illustrating an exemplary learning and adaptation cycle within a dynamic human-PCM interaction system, in an embodiment. The process may enable operational learning system 160 to capture interaction patterns, evaluate performance outcomes, and generate adaptations that improve human-PCM collaboration effectiveness over time through manifold modifications and parameter adjustments.

The process may begin when command sequence extractor 411 within interaction pattern analyzer 410 captures ongoing human-PCM interactions from translation engine 103, recording command sequences, timing patterns, and contextual conditions associated with each exchange 901.

Response effectiveness evaluator 412 may measure outcomes of PCM responses by tracking operator acceptance rates, task completion times, error frequencies, and corrective actions that may indicate how well PCM outputs align with operational needs 902.

Collaboration rhythm detector 413 may analyze temporal patterns in the interaction stream, identifying recurring sequences such as preferred pacing, natural pause points, peak performance periods, and fatigue cycles 903.

Error pattern recognizer 414 may examine instances where PCM responses required correction or override, extracting precursor conditions, common failure modes, and environmental factors correlated with reduced performance 904.

Preference profiler 415 may synthesize observations from processors 411 through 414 to build models of operator styles including risk tolerance thresholds, preferred detail levels, decision-making strategies, and communication patterns under varying cognitive loads 905.

Mission outcome correlator 421 within performance optimizer 420 may receive operator profile data and link specific interaction patterns to mission success metrics, identifying collaboration styles and PCM behaviors correlated with positive outcomes 906.

Decision quality assessor 422 may compare joint human-PCM decisions against benchmarks or expert standards when available, quantifying the effectiveness of the collaborative decision-making process 907.

Resource efficiency calculator 423 may evaluate cognitive and computational cost trade-offs of different interaction patterns, assessing how effectively the system reduces operator burden while maintaining mission performance 908.

Trust evolution tracker 424 may monitor changes in operator confidence toward PCM capabilities over time, correlating trust fluctuations with specific events, decisions, and outcomes to model trust dynamics 909.

Adaptation effectiveness measurer 425 may quantify improvements achieved from prior learning cycles by comparing current performance metrics against historical baselines, determining whether prior adaptations enhanced collaboration 910.

The system may then direct the adaptation process along different paths depending on whether performance has improved or degraded relative to baseline 911.

When performance has not improved, threshold adjuster 441 within adaptation engine 440 may modify operational parameters such as authority transition points, cognitive load limits, and trust boundaries based on accumulated evidence 912.

When performance has improved, thought bundle generator 443 may encode successful interaction patterns and solution strategies into reusable cognitive structures for activation in future situations 913.

Geodesic path modifier 442 may adjust the curvature and connection structure of latent manifold 150 to strengthen reasoning trajectories associated with positive outcomes while increasing resistance along paths associated with poor outcomes, thereby influencing attention flow within the cognitive substrate 914.

Authority zone sculptor 444 may reshape the boundaries of autonomous operation regions within latent manifold 150 based on demonstrated PCM competence and operator trust levels, expanding zones where performance has been reliable and constraining regions of uncertainty 915.

Persistent memory manager 170 may receive and store manifold modifications from geodesic path modifier 442 and authority zone sculptor 444, preserving learned adaptations including adjusted parameters, modified thought bundles, and reshaped manifold structures for long-term retention 916.

Response template builder 445 may generate updated formatting rules and presentation templates based on observed operator comprehension patterns, creating customized output formats that align with individual processing preferences 917.

The system may apply the generated adaptations to subsequent interactions, implementing modified thresholds through cognitive load balancer 125, updated manifold structures through cognitive dynamics engine 130, and new response templates through translation engine 103 918.

The adaptation cycle may then continue by monitoring new interactions with the applied modifications, creating a continuous feedback loop that captures performance data for further refinements 919. Through this iterative learning and adaptation cycle, operational learning system 160 may support the PCM in adapting from a general-purpose cognitive system toward a personalized partner optimized for specific operators, teams, and mission profiles, thereby enhancing collaboration effectiveness through accumulated operational experience.

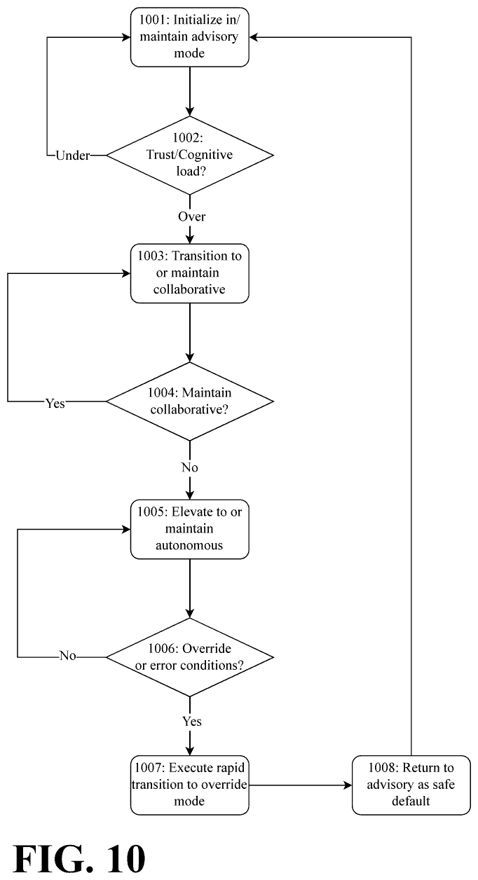

FIG. 10 is a flow diagram illustrating an exemplary operational mode transition process within a dynamic human-PCM interaction system, in an embodiment. The state machine may govern authority allocation between human operators and PCM systems through trust-based transitions while maintaining operational safety with hysteresis controls and emergency override capabilities.

The system may initialize in advisory mode where PCM may provide suggestions and recommendations without execution authority, maintaining this conservative stance when trust score remains below 0.65 so that human operators retain full decision-making control during initial interactions or low-trust conditions 1001.

Mode state machine 232 within authority manager 230 may continuously evaluate trust score from trust score calculator 231 and cognitive load score from cognitive load score calculator 215 to determine whether transition conditions are satisfied 1002.

When trust score exceeds 0.65 and cognitive load score exceeds 0.60 with more than three tasks queued, hysteresis controller 234 may initiate transition to collaborative mode where human and PCM share decision authority, with PCM handling routine tasks while the human maintains oversight of critical decisions 1003.

While in collaborative mode, the system may continue monitoring trust and load metrics, maintaining shared authority when trust remains between 0.65 and 0.80 and reverting to advisory mode if trust drops below 0.60 or significant errors are detected 1004.

When trust score exceeds 0.80 and cognitive load score exceeds 0.85, indicating high operator burden with demonstrated PCM reliability, transition threshold monitor 233 may trigger elevation to autonomous mode where PCM assumes primary execution authority within predetermined operational boundaries 1005.

During autonomous operation, the system may monitor for override signals, trust degradation below 0.40, critical errors, or uncertainty exceeding 0.30, any of which may trigger immediate mode transitions to preserve operational integrity 1006.

Upon detection of an override signal or critical error, transfer protocol manager 242 within handoff controller 240 may execute transition to override mode in less than 50 milliseconds, granting human operator 100 complete control while preserving system state for potential recovery 1007.

Following stabilization in override mode, the system may return to advisory mode as a default safe state, resetting the trust-building cycle while retaining learned parameters from the operational sequence 1008.

Through this controlled state transition mechanism, the system may dynamically adjust authority allocation based on real-time assessment of operator capacity and demonstrated PCM reliability, supporting operational safety through conservative defaults, graduated authority increases, and immediate override capabilities when anomalies occur.

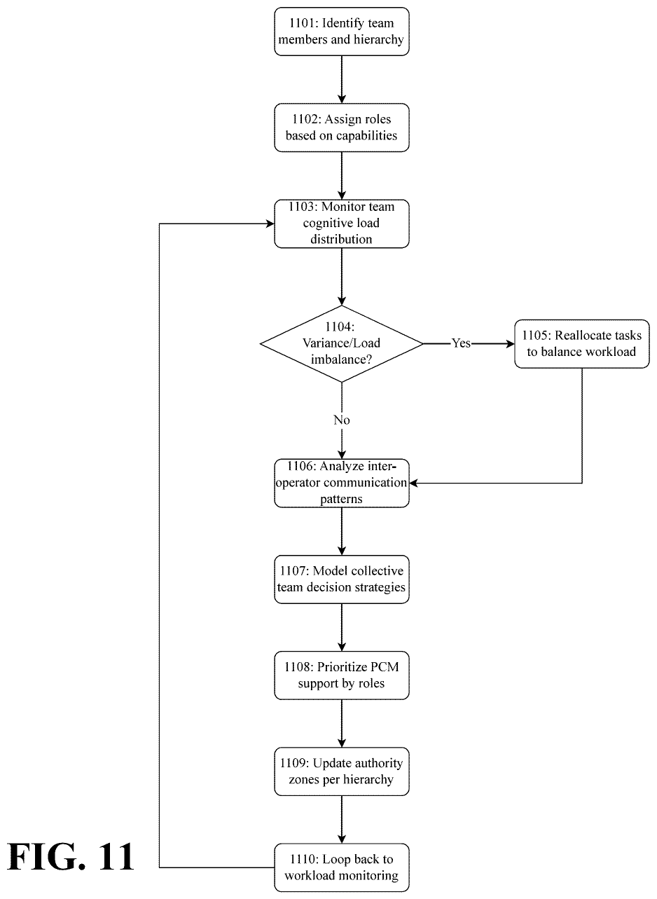

FIG. 11 is a flow diagram illustrating an exemplary team coordination process within a dynamic human-PCM interaction system, in an embodiment. The process may enable team dynamics processor 430 to manage multi-operator scenarios where multiple human operators collaborate with shared PCM resources, supporting workload distribution and facilitating collective decision-making.

The process may begin when operator coordination mapper 431 within team dynamics processor 430 identifies active team members through authentication credentials, communication channels, and operational assignments, establishing the current team composition and hierarchical relationships 1101.

Role specialization detector 432 may analyze team member capabilities, historical performance data, and mission requirements to assign functional responsibilities, for example determining primary operators for specific task domains and identifying leadership structures within the team 1102.

Workload distribution analyzer 433 may continuously measure cognitive load across all team members using individual cognitive load scores from their respective cognitive load balancers 125, calculating load variance to identify imbalances that could affect team performance 1103.

The system may evaluate whether cognitive load distribution across team members exceeds acceptable variance thresholds, detecting situations where some operators experience higher burden while others retain available capacity 1104.

When load imbalance is detected, task allocator 220 may redistribute pending tasks from overloaded operators to those with available capacity, considering role assignments and authority levels to maintain appropriate task-operator matching 1105.

Communication pattern extractor 434 may monitor inter-operator message exchanges, identifying critical communication pathways, information bottlenecks, and coordination patterns that characterize team dynamics 1106.

Collective decision modeler 435 may synthesize inputs from multiple operators when collaborative decisions are required, applying decision strategies such as weighted voting based on expertise, role authority, and confidence levels to generate unified team outcomes 1107.

The system may allocate PCM computational resources and attention based on team roles and current operational demands, prioritizing support for operators in critical positions or experiencing high cognitive load 1108.

Authority zone sculptor 444 within adaptation engine 440 may update manifold authority boundaries for each operator based on their role, maintaining differentiated access levels that reflect team hierarchy and functional specialization 1109.

The system may continue monitoring team dynamics through the established cycle, returning to workload analysis to detect emerging imbalances and maintain adaptive distribution of cognitive burden across the team 1110.

Through this coordination process, team dynamics processor 430 may support multi-operator teams by balancing workload, facilitating communication, synthesizing collective decisions, and maintaining role-appropriate authority allocations.

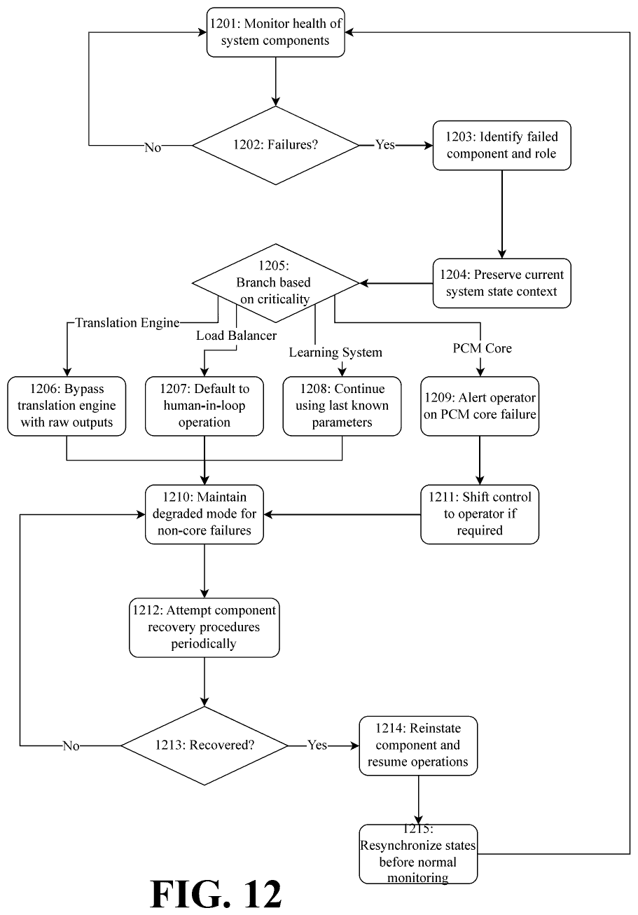

FIG. 12 is a flow diagram illustrating an exemplary failure recovery process within a dynamic human-PCM interaction system, in an embodiment. The process may enable resilient operation through component failure detection, graceful degradation, and systematic recovery while maintaining operational continuity to the maximum extent possible.

The process may begin with continuous system health monitoring that tracks operational status of major components including translation engine 103, cognitive load balancer 125, operational learning system 160, and PCM core components through heartbeat signals and performance metrics 1201.

The monitoring system may evaluate component responses against expected parameters to detect failures such as non-responsive modules, out-of-range outputs, or communication timeouts that indicate potential component malfunction 1202.

Upon detecting a component failure, the system may identify the specific failed component type and its role within the overall architecture to determine an appropriate degradation strategy 1203.

Context state capturer 241 within handoff controller 240 may preserve current system state including active task allocations, operator context, reasoning chains, and pending decisions to reduce data loss during failure handling 1204.

The system may evaluate whether the failed component is critical to core operations, directing the process along different degradation pathways depending on the specific component affected and its impact on system functionality 1205.

When translation engine 103 fails, the system may degrade to outputting raw reasoning chains from decoder 180 directly to output generator 190, bypassing normal adaptation processes while maintaining basic communication capability 1206.

When cognitive load balancer 125 fails, the system may default to a conservative human-in-loop mode with minimal PCM autonomy, supporting safety through reduced automation 1207.

When operational learning system 160 fails, the system may continue operation using last known good parameters from persistent memory manager 170, maintaining current performance levels without additional adaptation capability 1208.

When PCM core components fail, the system may alert human operator 100 and provide the last known valid state information, enabling manual takeover while preserving situational context 1209.

For non-core component failures, the system may continue operation in degraded mode with reduced functionality while maintaining primary mission capabilities through alternate processing pathways or simplified operations 1210.

For core component failures requiring manual intervention, human operator 100 may assume direct control using preserved state information until recovery can be attempted 1211.

The system may periodically attempt to recover failed components through reinitialization, connection reestablishment, or module restart procedures while continuing degraded or manual operation 1212.

Following each recovery attempt, the system may verify whether the failed component has returned to normal operation through diagnostic checks and test transactions 1213.

When recovery succeeds, the system may restore full functionality by reintegrating the recovered component into active processing chains and resuming normal operational modes 1214.

Following successful recovery, the system may resynchronize all component states through state synchronizer 340, supporting consistent operational context across modules before returning to normal monitoring 1215.

Through this systematic failure recovery process, the system may maintain operational capability during component failures while supporting safe degradation and providing pathways for recovery, thereby supporting robust operation in demanding environments where component failures may occur.

### Exemplary Computing Environment

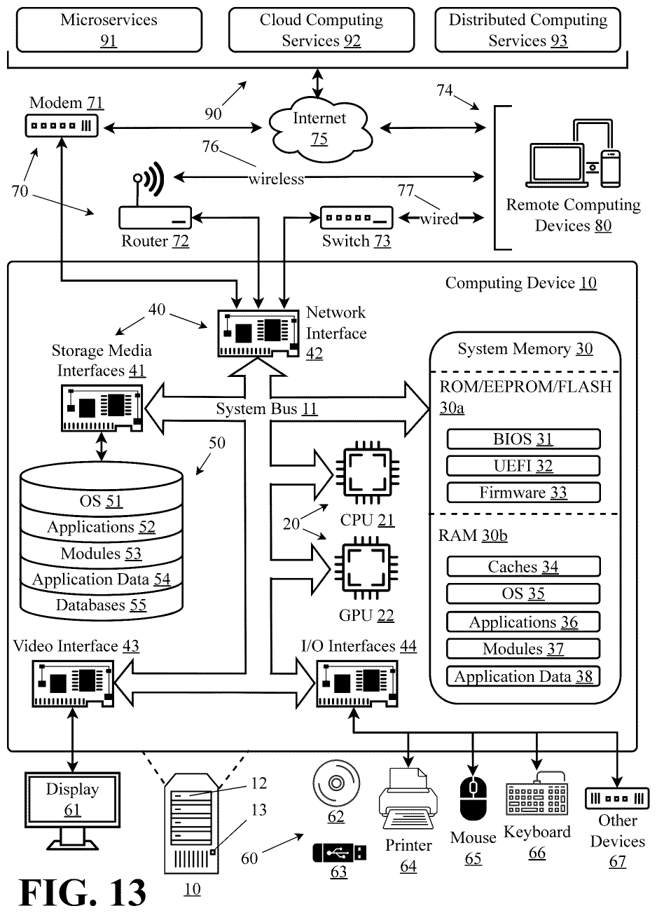

FIG. 13 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
receive multimodal inputs from a human operator, the multimodal inputs including at least one of voice commands, gestures, biometric signals, or environmental context;
convert the multimodal inputs into processable prompts for a persistent cognitive core using a translation engine that adapts input representation based on operator state and operational context;
process the prompts in the persistent cognitive core using domain-specific reasoning structures, multi-stage language model processing, and a thought caching architecture to generate reasoning outputs;
compute a cognitive load score for the human operator by fusing a plurality of physiological or behavioral signals calibrated to operator baseline values;
allocate tasks between the human operator and the persistent cognitive core based on the cognitive load score, a task complexity assessment, and a trust metric quantifying operator confidence in autonomous execution;
select an operational mode from among advisory, collaborative, autonomous, and override modes based on the trust metric and the cognitive load score;
adapt the reasoning outputs into human-appropriate formats based on the selected operational mode, including by adjusting at least one of a level of detail, an output modality, or a timing of delivery;
capture operator interaction patterns, performance outcomes, and team dynamics in an operational learning system; and
modify at least one of authority thresholds, output formatting templates, or reasoning pathways based on the captured interaction patterns to continuously improve future human- machine collaboration.

2. The computer system of claim 1, wherein computing the cognitive load score comprises weighting and summing normalized values of pupil dilation, heart rate variability, gaze distribution entropy, response latency, blink rate suppression, and skin conductance amplitude, calibrated against operator baseline values.

3. The computer system of claim 1, wherein allocating tasks comprises applying dynamic programming to minimize a total cost function including human effort cost, machine effort cost, and handoff penalties, subject to constraints that limit human cognitive load below a critical threshold, require machine confidence above a minimum threshold for autonomous action, and restrict handoff frequency.

4. The computer system of claim 1, wherein the trust metric is computed from a base trust value adjusted by at least one of incremental increases for successful autonomous decisions, decreases for operator overrides, decreases for critical errors, consistency of decision quality, or recovery from prior errors.

5. The computer system of claim 1, wherein selecting an operational mode comprises transitioning between advisory, collaborative, autonomous, and override modes in accordance with thresholds on the cognitive load score and trust metric, with hysteresis bands, minimum mode durations, and cooldown periods to prevent oscillation.

6. The computer system of claim 1, wherein adapting reasoning outputs comprises selecting a level of detail, a sensory modality, and a temporal pacing of information delivery according to the cognitive load score, including concise outputs under elevated load and detailed outputs under reduced load.

7. The computer system of claim 1, wherein modifying authority thresholds, output templates, or reasoning pathways comprises generating reusable reasoning structures from repeated successful interactions and adjusting authority transition thresholds based on accumulated trust and operator performance.

8. The computer system of claim 1, wherein the computer system is further configured to degrade gracefully under component failure by outputting raw reasoning chains if a translation engine fails, reverting to human-in-loop control if a cognitive load balancer fails, retaining validated parameters if an operational learning system fails, or alerting the operator and preserving state if a persistent cognitive core fails.

9. The computer system of claim 1, wherein the operational learning system is configured to share abstracted adaptation patterns across a plurality of persistent cognitive machines, while excluding raw operational data to maintain privacy and security.

10. The computer system of claim 1, wherein capturing team dynamics comprises monitoring workload distribution across multiple operators, redistributing tasks to balance cognitive loads, analyzing communication patterns, and generating collective decision outcomes through weighted voting or consensus modeling.

11. A computer-implemented method comprising executing software instructions stored on nontransitory machine-readable storage media, the method comprising:
receiving multimodal inputs from a human operator, the multimodal inputs including at least one of voice commands, gestures, biometric signals, or environmental context;
converting the multimodal inputs into processable prompts for a persistent cognitive core using a translation engine that adapts input representation based on operator state and operational context;
processing the prompts in the persistent cognitive core using domain-specific reasoning structures, multi-stage language model processing, and a thought caching architecture to generate reasoning outputs;
computing a cognitive load score for the human operator by fusing a plurality of physiological or behavioral signals calibrated to operator baseline values;
allocating tasks between the human operator and the persistent cognitive core based on the cognitive load score, a task complexity assessment, and a trust metric quantifying operator confidence in autonomous execution;
selecting an operational mode from among advisory, collaborative, autonomous, and override modes based on the trust metric and the cognitive load score;
adapting the reasoning outputs into human-appropriate formats based on the selected operational mode, including by adjusting at least one of a level of detail, an output modality, or a timing of delivery;
capturing operator interaction patterns, performance outcomes, and team dynamics in an operational learning system; and
modifying at least one of authority thresholds, output formatting templates, or reasoning pathways based on the captured interaction patterns to continuously improve future human- machine collaboration.

12. The method of claim 11, wherein computing the cognitive load score comprises weighting and summing normalized values of pupil dilation, heart rate variability, gaze distribution entropy, response latency, blink rate suppression, and skin conductance amplitude, calibrated against operator baseline values.

13. The method of claim 11, wherein allocating tasks comprises applying dynamic programming to minimize a total cost function including human effort cost, machine effort cost, and handoff penalties, subject to constraints that limit human cognitive load below a critical threshold, require machine confidence above a minimum threshold for autonomous action, and restrict handoff frequency.

14. The method of claim 11, wherein computing the trust metric comprises adjusting a base trust value by at least one of incremental increases for successful autonomous decisions, decreases for operator overrides, decreases for critical errors, consistency of decision quality, or recovery from prior errors.

15. The method of claim 11, wherein selecting the operational mode comprises transitioning between advisory, collaborative, autonomous, and override modes in accordance with thresholds on the cognitive load score and trust metric, with hysteresis bands, minimum mode durations, and cooldown periods to prevent oscillation.

16. The method of claim 11, wherein adapting the reasoning outputs comprises selecting a level of detail, a sensory modality, and a temporal pacing of information delivery according to the cognitive load score, including concise outputs under elevated load and detailed outputs under reduced load.

17. The method of claim 11, wherein modifying authority thresholds, output templates, or reasoning pathways comprises generating reusable reasoning structures from repeated successful interactions and adjusting authority transition thresholds based on accumulated trust and operator performance.

18. The method of claim 11, further comprising degrading gracefully under component failure by outputting raw reasoning chains if a translation engine fails, reverting to human-in-loop control if a cognitive load balancer fails, retaining validated parameters if an operational learning system fails, or alerting the operator and preserving state if a persistent cognitive core fails.

19. The method of claim 11, wherein capturing interaction patterns further comprises sharing abstracted adaptation patterns across a plurality of persistent cognitive machines, while excluding raw operational data to maintain privacy and security.

20. The method of claim 11, wherein capturing team dynamics comprises monitoring workload distribution across multiple operators, redistributing tasks to balance cognitive loads, analyzing communication patterns, and generating collective decision outcomes through weighted voting or consensus modeling.
